(19) United States
(12) Patent Application Publication
(10) Pub. No.: US 2024/0328791 A1
(43) Pub. Date: Oct. 3, 2024

(54) APPARATUS, METHOD, AND COMPUTER PROGRAM PRODUCT FOR GENERATING BLUEPRINTS FOR NAVIGATION THROUGH OPERATIONAL SYSTEMS

(71) Applicant: Honeywell International Inc., Charlotte, NC (US)

(72) Inventors: Veeranagegowda Shivalingappa, Chitradurga (IN); Sumanth Pachipulusu Lingesh, Bengaluru (IN); R. Dhawan Kumar, Hyderabad (IN)

(21) Appl. No.: 18/190,472

(22) Filed: Mar. 27, 2023

(51) Int. Cl. G01C 21/20

(52) U.S. Cl. CPC G01C 21/206

(57) ABSTRACT

A service navigation system receives navigation selection input (e.g., via a navigation selection interface) with respect to service operations to be performed on an operational system located at a premises, generates spatial data based on the received input and an extensible object model (e.g., stored in a graph database) representing the operational system, transmits the spatial data to service devices associated with the operational system, and causes performance of navigation operation(s) with respect to the premises and/or the operational system based on the spatial data, including generating and presenting a blueprint depicting a selected portion of the operational system and/or premises, generating and presenting navigation data by an indoor navigation device associated with an indoor navigation system for the premises, and/or causing an autonomous mobile device to move through the operational system and/or premises based on the spatial data.

### TECHNICAL FIELD

Embodiments of the present disclosure generally relate to extensible object models for operational systems, and specifically, in some examples, to navigation through operational systems using extensible object models representing the operational systems.

### BACKGROUND

Applicant has identified example technical challenges and difficulties associated with current solutions for navigation through operational systems. Through applied effort, ingenuity, and innovation, Applicant has solved problems relating to navigation through operational systems.

### BRIEF SUMMARY

According to one aspect, example embodiments of the present disclosure include an apparatus comprising at least one processor and at least one non-transitory memory comprising program code stored thereon. The at least one non-transitory memory and the program code are configured to, with the at least one processor, cause the apparatus to at least receive navigation selection input indicating a selected portion of one or more operational systems at a premises, generate spatial data representing the selected portion of the one or more operational systems based at least in part on the navigation selection input and on one or more extensible object models representing the one or more operational systems, transmit the spatial data to one or more service devices associated with the one or more operational systems, and cause the one or more service devices to perform one or more navigation operations with respect to the premises and the one or more operational systems based at least in part on the spatial data.

In some embodiments, the one or more service devices include a mobile computing device operated by a technician associated with the one or more operational systems, and the one or more navigation operations include generating and presenting a blueprint based at least in part on the spatial data, the blueprint comprising a graphical depiction of a layout of an area of the premises containing the selected portion of the one or more operational systems with graphical elements representing assets of the one or more operational systems included in the selected portion of the one or more operational systems. Positions of the graphical elements with respect to the graphical depiction of the layout of the area of the premises are based at least in part on the spatial data. The at least one non-transitory memory and the program code may be configured to, with the at least one processor, further cause the apparatus to at least: retrieve service specification data associated with the assets; and present graphical elements representing the service specification data for each of the assets as part of the blueprint.

In some embodiments, the one or more service devices include an autonomous mobile device configured to perform service on assets of the one or more operational systems, and the one or more navigation operations include the autonomous mobile device automatically moving through the premises to assets of the one or more operational systems included in the selected portion of the one or more operational systems based at least in part on the spatial data.

In some embodiments, the one or more navigation operations include generating and presenting navigation data via an indoor navigation system associated with the premises based at least in part on the spatial data.

In some embodiments, the at least one non-transitory memory and the program code are configured to, with the at least one processor, further cause the apparatus to at least: present a navigation selection interface configured to receive the navigation selection input; and receive, via the navigation selection interface, the navigation selection input. The navigation selection interface may comprise one or more interactable elements configured to receive input indicative of selections of selected regions, sites, zones, and/or floors of the premises, selected assets of the one or more operational system, and/or selected service operations to be performed with respect to the one or more operational systems.

In some embodiments, the at least one non-transitory memory and the program code are configured to, with the at least one processor, further cause the apparatus to at least: retrieve asset permissions data associated with a current user and the selected portion of the one or more operational systems; and cause the one or more service devices to perform the one or more navigation operations based at least in part on the asset permissions data.

In some embodiments, the at least one non-transitory memory and the program code are configured to, with the at least one processor, further cause the apparatus to at least: retrieve from an access control system for the premises access control data associated with a current user and one or more areas of the premises containing the selected portion of the one or more operational systems; and cause the one or more service devices to perform the one or more navigation operations based at least in part on the asset permissions data.

In some embodiments, the spatial data comprises premises layout data for the premises, location data indicating a location with respect to the premises of the selected portion of the one or more operational system, position data indicating positions of assets included in the selected portion of the one or more operational systems with respect to a layout of the premises and/or other assets, and/or asset data identifying and/or characterizing assets included in the selected portion of the one or more operational systems and/or functional relationships between the identified assets.

According to another aspect, embodiments of the present invention feature a method comprising receiving navigation selection input indicating a selected portion of one or more operational systems at a premises, generating spatial data representing the selected portion of the one or more operational systems based at least in part on the navigation selection input and on one or more extensible object models representing the one or more operational systems, transmitting the spatial data to one or more service devices associated with the one or more operational systems, and causing the one or more service devices to perform one or more navigation operations with respect to the premises and the one or more operational systems based at least in part on the spatial data.

According to another aspect, embodiments of the present invention feature a computer program product comprising at least one non-transitory computer-readable storage medium having computer-readable program code portions stored therein. The computer-readable program code portions comprise an executable portion configured to: receive navigation selection input indicating a selected portion of one or more operational systems at a premises, generate spatial data representing the selected portion of the one or more operational systems based at least in part on the navigation selection input and on one or more extensible object models representing the one or more operational systems, transmit the spatial data to one or more service devices associated with the one or more operational systems, and cause the one or more service devices to perform one or more navigation operations with respect to the premises and the one or more operational systems based at least in part on the spatial data.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block diagram of an example apparatus that may be specially configured in accordance with an example embodiment of the present disclosure;

FIG. 3 illustrates an exemplary service navigation system, in accordance with at least some example embodiments of the present disclosure;

FIG. 4 illustrates an exemplary navigation selection screen presented within a graphical user interface, in accordance with at least some example embodiments of the present disclosure;

FIG. 5 illustrates an exemplary blueprint screen presented within a graphical user interface, in accordance with at least some example embodiments of the present disclosure;

FIG. 6 illustrates an exemplary blueprint screen presented within a graphical user interface, in accordance with at least some example embodiments of the present disclosure;

FIG. 7 is a flowchart depicting an example process for generating spatial data based on an extensible object model, in accordance with at least some example embodiments of the present disclosure; and

FIG. 8 is a flowchart depicting an example process for initiating navigation operations based on asset permissions data, access control data, and/or service specification data, in accordance with at least some example embodiments of the present disclosure.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

The use of the term “circuitry” as used herein with respect to components of a system or an apparatus should be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, communication circuitry, input/output circuitry, and the like. In some embodiments, other elements may provide or supplement the functionality of particular circuitry. Alternatively or additionally, in some embodiments, other elements of a system and/or apparatus described herein may provide or supplement the functionality of another particular set of circuitry. For example, a processor may provide processing functionality to any of the sets of circuitry, a memory may provide storage functionality to any of the sets of circuitry, communications circuitry may provide network interface functionality to any of the sets of circuitry, and/or the like.

The term “electronically coupled,” “electronically coupling,” “electronically couple,” “in communication with,” “in electronic communication with,” or “connected” in the present disclosure refers to two or more elements or components being connected through wired means and/or wireless means, such that signals, electrical voltage/current, data and/or information may be transmitted to and/or received from these elements or components.

Operational systems such as building systems (e.g., heating, ventilation, and air conditioning (HVAC) systems, building automation systems, security systems) and/or industrial systems (e.g., manufacturing systems, sorting and distribution systems) are configured, in some examples, to monitor and/or control various physical aspects of a premises, building, site, location, environment, mechanical system, industrial plant or process, laboratory, manufacturing plant or process, vehicle, utility plant or process, and/or the like. An operational system comprises various assets, including, in some examples, equipment (e.g., controllers, sensors, actuators) configured to perform the functionality attributed to the operational system and/or components, devices, and/or subsystems of the operational system. In some examples, the operational system, via its various assets, may monitor and/or control operation of a residential or commercial building or premises (e.g., HVAC systems, security systems, building automation systems, and/or the like). In other examples, the operational system may monitor and/or control operation of a manufacturing plant (e.g., manufacturing machinery, conveyor belts, and/or the like). In yet other examples, the operational system may monitor and/or control operation of a vehicle.

Often, a given enterprise may be responsible for the management of several operational systems, across several sites and locations, each comprising several (e.g., possibly thousands) of assets. Management of such systems often includes monitoring conditions and/or performance of the systems' assets, facilitating and/or performing service on or physical maintenance of the assets, and/or controlling the assets in order to optimize the assets' and systems' performance and/or fulfill other objectives of the enterprise.

Enterprise performance management (EPM) systems have been proposed to monitor and maintain operational systems. For example, in some operational systems, it has been proposed to communicatively connect operational system(s), including assets of the operational system(s), to a remote monitoring system (e.g., a cloud platform) configured to aggregate operational data with respect to some or all of the assets of one or more operational systems (e.g., deployed at one or more sites or locations). This operational data may comprise sensor data (e.g., generated via assets such as sensors of the operational system) or any other data generated with respect to and/or describing operation of the operational systems and/or assets thereof. The monitoring system may also aggregate and/or maintain operational system context data defining various attributes (e.g., relationships, types, locations, roles) associated with the assets of the operational system and other objects associated with the operational system. This operational data and operational system context data may be collected, archived, and consulted in order to provide visibility into and perform various control operations with respect to the operational system(s), for example. These monitoring systems may be configured to provide, for each enterprise, an enterprise-wide, top-to-bottom, historical and/or real-time, view of the status of various processes, assets, people, and/or other objects associated with all of the operational system(s) managed by the enterprise. The monitoring systems may be configured to generate and present insights (e.g., predictions and/or recommendations) for optimizing performance of the operational system(s) and assets thereof. These insights are often generated using machine learning models, which may be developed, configured, and/or trained using one or more machine learning algorithms.

It has been proposed for some of these EPM systems to utilize graph database technology in order to represent operational systems and any objects related to such systems. A graph database uses graph structures, including data objects forming nodes and edges, each node representing an object relevant to an operational system and each edge defining a relationship between a pair of nodes. In such structures, properties may be defined for nodes and/or edges.

More particularly, operational system context data maintained by an EPM system may comprise an extensible object model and/or an extensible graph-based object model associated with each of the operational system(s). This extensible object model may comprise knowledge graphs that model assets and/or processes of and/or associated with the operational system(s). In one example, knowledge graphs of the operational system context data may define a collection of nodes and links that describe or represent real-world connections between the operational system(s) and/or assets thereof. A knowledge graph of the operational system context data may describe real-world entities (e.g., assets) and their interrelations organized in a graphical interface, may define possible classes and relations of entities or objects associated with the operational system(s) in a schema, may enable interrelating arbitrary entities or objects with each other, and/or may cover various topical domains associated with the operational system(s). Knowledge graphs of the operational system context data may define large networks of entities (e.g., assets), semantic types of the entities, properties of the entities, and relationships between the entities. The knowledge graphs of the operational system context The extensible object models are not limited to abstract concepts and relation but can also contain instances of objects, such as, for example, documents and datasets. In some embodiments, the knowledge graphs of the operational system context data may include resource description framework (RDF) graphs. As used herein, a “RDF graph” is a graph data model that formally describes the semantics, or meaning, of information. The RDF graph also represents metadata (e.g., data that describes data). According to various embodiments, extensible object models may also include a semantic object model, which may be a subset of a knowledge graph that defines semantics for the extensible object model. For example, a semantic object model may define a schema for an extensible object model.

One advantage provided by the use of extensible object models to represent operational systems is the ability to extend any aspect of a given model by simply adding new nodes representing new objects and/or new edges representing new relationships between the various objects. For example, a different type of extensible object model can be defined for each of a series of different types of operational systems, with each model type comprising a generic set of predefined, classes, objects, nodes, edges, and/or relationships. At the same time, each of these different types can be built upon and extended in different ways with respect to particular operational systems and/or particular enterprises to suit the different needs associated with the particular systems and/or enterprises.

Managing, organizing, scheduling, and/or performing service operations with respect to operational systems located at different sites with different spatial features, sometimes having assets distributed throughout large, sprawling premises has posed a particular challenge for enterprises that manage these operational systems. Maps or blueprints, if they are available at all, may be outdated, not reflecting changes to the premises and/or to the operational system that have occurred subsequent to the original preparation of the blueprint. Service personnel would also have to look elsewhere for any information about the premises that is relevant to a service operation but is not provided on the maps or blueprints, while the maps or blueprints likely provide information with respect to an entire premises or area thereof without regard for the needs of service personnel or service devices specific to a particular service operation. In some instances, such maps or blueprints might even expose sensitive information that is not necessary for a given service operation.

At the same time, it is possible for these extensible object models not only to represent operational systems but also to represent the premises or sites where operational systems are installed or located. For example, nodes representing various features of the premises can be arranged (e.g., via relationships or edges) hierarchically, with a higher level node representing a building where an operational system is installed and connected to lower level nodes representing each floor of the building, which may be further connected to lower level nodes representing various spaces on each of the floors. This spatial data provided by the extensible object model may be further connected to various objects associated with the operational system(s), with various nodes representing spatial features of the premises connected to those representing assets, points, sensors, assets, features, and/or processes of the operational system(s).

Examples of the present disclosure concern a service navigation system that enables customizable generation of accurate and up to date spatial data (including blueprints and/or navigation data) that incorporates additional data specific to a particular operational system, premises, and/or service operation while also masking any sensitive data based on a current user. The service navigation system may be configured to generate the spatial data with respect to a selected portion of an operational system, and the spatial data may be generated on demand based on the most up to date extensible object model representing the operational system and/or the premises. Integration between the service navigation system and an access control system allows the service navigation system, for example, to include in the generated spatial data access control data associated with the various spaces or areas of a premises relevant to the selected portion of the operational system, including, for example, indications of whether a current user (e.g., requesting the spatial data or blueprint) will be able to access the various areas depicted in the spatial data and/or whether it will be necessary to request access in anticipation of a service operation. In one example, the service navigation system may be configured to present or expose an interface for selecting a region, site, zone, and/or floor of a premises and to generate spatial data representing the selected locations. The spatial data may be provided to one or more service devices, including autonomous mobile devices (e.g., robots) configured to automatically navigate through the premises to perform service operations, indoor navigation devices, and/or mobile computing devices operated by service technicians. Various assets or other objects represented in the extensible object model may comprise permissions data indicating which users and/or groups of users may have access to the assets or objects, and the service navigation system may be configured to generate the spatial data to only include data concerning the assets or objects that a current user (e.g., requesting the spatial data) is permitted to access in the permissions data. The spatial data can also be generated to include additional data such as indications of what equipment are required for the service operation and/or whether any of the assets identified in the spatial data are located in sensitive, restricted, and/or hazardous areas.

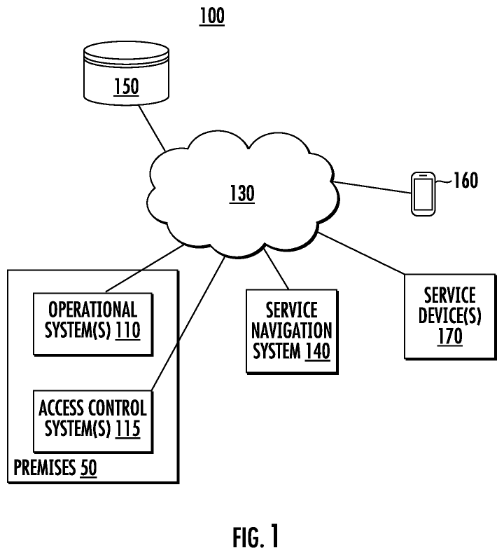

FIG. 1 illustrates an exemplary block diagram of an environment 100 in which embodiments of the present disclosure may operate. Specifically, FIG. 1 illustrates one or more operational systems 110 located at a premises 50, one or more access control systems 115 located at the premises 50, a service navigation system 140, one or more data repositories 150, one or more user devices 160, and one or more service devices 170, all connected to a network 130.

The network 130 may be embodied in any of a myriad of network configurations. In some embodiments, the network 130 may be a public network (e.g., the Internet). In some embodiments, the network 130 may be a private network (e.g., an internal localized, or closed-off network between particular devices). In some other embodiments, the network 130 may be a hybrid network (e.g., a network enabling internal communications between particular connected devices and external communications with other devices). In various embodiments, the network 130 may include one or more base station(s), relay(s), router(s), switch(es), cell tower(s), communications cable(s), routing station(s), and/or the like. In various embodiments, components of the environment 100 may be communicatively coupled to transmit data to and/or receive data from one another over the network 130. Such configuration(s) include, without limitation, a wired or wireless Personal Area Network (PAN), Local Area Network (LAN), Metropolitan Area Network (MAN), Wide Area Network (WAN), and/or the like.

The one or more data repositories 150 may be configured to receive, store, and/or transmit data. In some embodiments, the one or more data repositories 150 store operational data collected from and/or associated with the one or more operational systems 110, operational system context data associated with the one or more operational systems 110, including possibly one or more extensible object models (e.g., each representing one of the one or more operational systems 110), premises layout data associated with the premises 50, service specification data associated with the extensible object model(s) and/or the operational system(s) 110, asset permissions data associated with the extensible object model(s) and/or the operational system(s) 110, and/or access control data associated with the access control system(s) 115, to list a few examples.

The one or more user devices 160 may be associated with users of the service navigation system 140, the operational system(s) 110, the access control system(s) 115, the service device(s) 170 and/or with individuals associated with the premises 50. In various embodiments, an enterprise management system (e.g., EPM system associated with the operational system(s) 110 and/or the service navigation system 140) may cause data associated with the one or more operational systems 110 (e.g., including operational data collected from and/or associated with the operational systems 110, data generated via the service navigation system 140, and/or some or all of the model data forming the one or more extensible object models) to be transmitted to and/or displayed on the user device(s) 160. The service navigation system 140 may cause data and/or interfaces associated with navigation through the premises 50 and/or operational system(s) 110 to be transmitted to and/or displayed on the user device(s) 160.

Each of the one or more operational systems 110 may be configured to monitor and/or control various physical aspects of the premises 50, which may refer to and/or comprise one or more buildings, sites, locations, environments, mechanical systems, industrial plants or processes, laboratories, manufacturing plants or processes, vehicles, and/or utility plants or processes, to name a few examples, via one or more assets of the one or more operational systems 110. The assets may be physical components (e.g., implemented at least via hardware) installed, positioned, and/or deployed throughout the premises 50 and/or the operational system(s) 110, including controllers, sensors, and/or actuators of various types, to list a few examples. The assets may include computing devices for executing instructions (e.g., stored in nonvolatile memory) for performing various functions of the operational system(s) 110, for example, by receiving sensor data from one or more sensors and controlling one or more actuators (e.g., based on the received sensor data). The assets may include field controllers of the operational system. In an example context, at least some of the assets of the operational system(s) 110 may each embody a computing device of one or more systems for operation of a residential building of the premise 50 (e.g., HVAC (heating, ventilation, and air conditioning) assets, security assets, and/or the like) such as controllers for directing the functionality of actuators such as air handlers, blowers, condensers, chillers, and/or dampers, to list a few examples. In another example context, at least some of the assets of the operational system(s) 110 may each embody a computing device of one or more systems for operation of a manufacturing plant of the premises 50 (e.g., HVAC assets, manufacturing machinery, conveyor belts, and/or the like) such as controllers for directing the functionality of actuators such as the manufacturing machinery and/or conveyor belts. Actuators of the one or more operational systems 110 may be activated and/or controlled to perform various physical operations of the operational system 110, including operations with respect to various features of the premises 50 where the operational system 110 is installed or located.

Sensors of the one or more operational system 110 may be configured to generate sensor data based on incorporated sensing elements and may include digital sensors, which generate and transmit digital sensor data based on conditions of the premises 50 sensed by sensing elements of the sensors, and/or analog sensors, which produce analog signals based on conditions of the premises 50 sensed by sensing elements of the sensors. The sensors may be configured to read and/or otherwise capture certain values associated with the premises 50 (e.g., building, site, location, environment, mechanical system, industrial plant or process, laboratory, manufacturing plant or process, and/or utility plant or process), or operations associated therewith or therein.

During design, installation, configuration, operation, and/or maintenance of the one or more operational systems 110, operational data and/or operational system context data associated with the one or more operational systems 110 may be generated.

In one example, during periods of operation of the operational system(s) 110, assets of the operational system(s) 110 may generate operational data based on and/or indicative of said operation, including sensor data, operational status data, operating conditions data, and/or operation logs (e.g., indicating operations performed by the system or assets thereof), to list a few examples. In another example, during configuration of the operational system(s), assets of the operational system(s) 110 may generate and/or receive system and/or asset configuration data of the operational data. In yet another example, other types of operational data may be generated (e.g., by the operational system(s) and/or external systems for managing the operational system(s) and/or an enterprise associated therewith), including operational system maintenance data based on and/or indicative of maintenance and/or service operations performed with respect to the operational system(s) 110 and/or operational system performance data based on and/or indicative of performance of the operational system(s) 110 with respect to one or more objectives of the enterprise.

The operational system context data for the operational system(s) 110 may comprise the extensible object model(s) representing the operational system(s) 110. In one example, an enterprise management system associated with the operational system(s) 110 may be configured to manage and/or maintain the one or more operational systems 110, including receiving, retrieving, and/or aggregating data associated with the operational systems(s) 110 and generating the operational system context data and/or the extensible object model(s) based on the received, retrieved, and/or aggregated data.

In some examples, the operational system context data associated with an operational system 110 may comprise an extensible object model associated with the operational system 110, as previously defined. The operational system context data and/or extensible object model associated with a given operational system may comprise metadata associated with various components and/or assets of the given operational system, for example, defining various attributes and/or characteristics of the assets and/or associations or relationships between the various assets. In one example, the operational system context data and/or extensible object model for an operational system may comprise an ontology model providing a representation of each of the various assets of the operational system, classification of the assets into various groups or categories, definition of various attributes of the assets and/or categories, and/or definition of associations between the various objects and/or categories referenced throughout the operational system context data.

The operational system context data and/or extensible object model(s) may include identification information for individual assets of the operational system, type information for the individual assets assigning types to each of the assets, properties associated with the identification information and/or the type information, locations of the assets within the operational system and/or an environment where the operational system is installed, functional and/or physical locations of the assets with respect to each other, relationships between the assets with respect to each other, relationships between types of the assets with respect to each other, and/or roles of the assets and/or types of assets within the operational system and/or within subsystems of the operational system, to name a few examples. The operational system context data and/or extensible object model(s) associated with a given operational system may comprise data and/or metadata associated with any objects associated with the given operational system, which objects may include assets and/or equipment of the one or more operational systems 110, sensors included in and/or associated with the one or more operational systems 110, alarms or alarm tasks associated with the one or more operational systems 110 (e.g., concerning required or recommended maintenance, anomalies, unsafe operating conditions), sites, locations, or regions containing the one or more operational systems 110 and/or any assets thereof, and/or individuals associated with the one or more operational systems 110, to name a few examples.

The operational system context data and/or extensible object model associated with a given operational system may comprise data and/or metadata defining objects representing management, maintenance, and/or service tasks associated with various assets of the operational systems, including, for example, alarms associated with certain assets or types of assets and representing configuration settings for generating alarm notifications concerning the need for certain maintenance operations associated with the assets or asset types.

The operational system context data and/or extensible object model(s) may further comprise and/or reference service specification data indicative of characteristics, requirements, and/or procedures associated with various types of maintenance and/or service operations that can be performed with respect to the operational system(s) 110 and/or associated with various types of assets, points, and/or other objects of the operational system(s) 110.

The operational system context data and/or extensible object model(s) may further comprise and/or reference asset permissions data indicative of access rights or permissions associated with particular assets and/or types of assets and particular users and/or groups of users.

The operational system context data and/or extensible object model(s) may further comprise and/or reference premises layout data indicative of various features of the premises 50 where each operational system 110 is installed or located, including hierarchical and/or graphical representations of entrances, exits, floors, zones, wings, rooms, hallways, doors, access points, stairways, elevators, escalators, defined areas and/or spaces, sites, campuses, regions, etc. The operational system context data, extensible object model(s), and/or premises layout data may define relationships among the various features of the premises 50, including proximity, adjacency, access capability (e.g., from one feature to another), and/or spatial hierarchy (e.g., one feature enclosing, having, and/or containing another feature, one feature being enclosed by, part of, and/or contained by another), to list a few examples. The operational system context data, extensible object model(s), and/or premises layout data may define relationships between objects associated with the operational system(s) 110 (e.g., assets, equipment, points, service operations) and the various features of the premises 50, including spatial hierarchy (e.g., an asset or other object being located at or within and/or contained by a feature of the premises 50) and/or operational hierarchy (e.g., an asset or other object having control over an environment or state at or within a feature of the premises 50), to name a few examples. The operational system context data, extensible object model(s), and/or premises layout data may even quantify spatial dimensions of various features of the premises 50 and precise spatial relationships between the features and other features or objects, including possibly defining one or more two- or three-dimensional coordinate systems associated with certain features of the premises 50 and indicating locations of other features 50 and/or locations of assets or other objects with respect to those features and/or coordinate systems (e.g., expressed as coordinate data).

The operational data and/or operational system context data (e.g., including the one or more extensible object models), the premises layout data, the service specification data, and/or the asset permissions data associated with the one or more operational systems 110 may be aggregated and/or stored in the one or more data repositories 150 and/or may be accessible by the service navigation system 140 and/or an enterprise management system.

The premises 50 where the operational system(s) 110 are located and/or installed may further comprise the access control system(s) 115, which may refer to a system for controlling and/or restricting access through various types of access points (e.g., doors, turnstiles, elevators, escalators, boom barriers, gates) of the premises 50 into restricted areas of the premises 50. The access control system(s) 115 may comprise various devices and/or assets distributed throughout the premises 50 at the controlled access points, including credential readers and/or controllable locks or other actuators for granting or restricting access through the access points, to name a few examples. The access control system(s) 115 may comprise one or more control panels or controllers for controlling the locks/actuators to grant or deny access to individuals at the access points based on, for example, identification data received via the credential readers. In some embodiments, the access control system(s) 115 may be configured with and/or may generate access control data indicative of which individuals, users, and/or groups of individuals or users are authorized to access which restricted areas and/or are authorized to pass through which access points. The access control data for the access control system(s) 115 may be stored in the one or more data repositories 150, for example.

In some embodiments and/or at some premises 50, the access control system(s) 115 may be included in and/or integrated with the operational system(s) 110. In some embodiments and/or at some premises 50, the access control system(s) 115 may be distinct from the operational system(s) 110 (e.g., managed and/or controlled by different systems and/or entities) but nevertheless in communication with the operational system(s) 110 for exchanging data and/or messages between the different systems (e.g., over the network 130).

The access control system(s) 115 may be configured to provide the access control data for the premises 50 to one or more requesting entities or systems, including, for example, the service navigation system 140. In one example, the access control system(s) 115 may provide the access control data in response to requests for the access control data received via an integration interface between the access control system(s) 115 and the service navigation system 140, enabling communication and data exchange between the two systems. In another example, the access control system(s) 115 may be integrated as part of the operational system(s) 110 and/or the service navigation system 140 and/or may be configured to store the access control data (e.g., in the one or more data repositories 150) such that the stored data is accessible to the service navigation system 140. In some examples, the access control data may be included as part of the operational system context data and/or the extensible object model(s).

The service navigation system 140 may be a computing system or device (e.g., server system) configured via hardware, software, firmware, and/or a combination thereof, to enable and/or facilitate navigation by individuals and/or autonomous devices through the one or more operational system(s) 110, for example, in connection with various service operations associated with the operational system(s) 110. These service operations may comprise inspection, testing, maintenance, repair, replacement, installation, and/or removal of assets of the operational system(s) 110, which may be performed by service technicians operating the service devices 170 and/or by the service devices 170 themselves. The service navigation system 140 may be configured to enable and/or facilitate navigation through the operational system(s) 110 by accessing and/or retrieving model data from the extensible object model(s) and possibly data from other sources. In some embodiments, the service navigation system 140 may comprise or may be integrated as part of an extensible object model system associated with the extensible object model(s) configured, extensible object model system being configured to generate, configure, modify, access, utilize, and/or manage the extensible object model(s). In some embodiments, the service navigation system 140 may access the extensible object model(s) by communicating with the extensible object model system (e.g., requesting and/or receiving the model data from the extensible object model system via an interface).

More particularly, the service navigation system 140 may be configured to present and/or expose one or more navigation selection interfaces, to receive (e.g., via the navigation selection interface(s)) and process navigation selection input with respect to the operational system(s) 110 and/or premises 50 (e.g., indicating a selected portion of the operational system(s), a selected portion of the extensible object model(s), and/or selected features of the premises 50), to generate spatial data associated with the operational system(s) 110 and/or premises 50 (e.g., representing the selected portion of the operational system(s) 110) based at least in part on the navigation selection input and on the extensible object model(s) representing the operational system(s) 110, to transmit the spatial data to the service device(s) 170 associated with the operational system(s) 110, and/or to cause the service device(s) 170 to perform one or more navigation operations with respect to the premises 50 and/or the operational system(s) 110 based at least in part on the spatial data.

The service device(s) 170 may include a mobile computing device (e.g., operated by a service technician associated with the operational system(s) 110 and/or the premises 50), an autonomous mobile device (e.g., robot) configured to perform the service operations on the assets of the operational system(s) 110, and/or indoor navigation devices associated with an indoor navigation system installed at the premises 50. The mobile computing device and/or the indoor navigation device of the service devices 170 may be user devices 160 configured with specialized firmware and/or software configured to cause the user devices 160 to perform the respective navigation operations based at least in part on the spatial data.

In some embodiments, the service navigation system 140 may be configured to generate the spatial data and/or cause the service device(s) 170 to perform the one or more navigation operations based at least in part on the premises layout data, service specification data, asset permissions data, and/or access control data. The spatial data may be generated to comprise the premises layout data, service specification data, asset permissions data, and/or access control data.

Additionally, in some embodiments, the service navigation system 140 may be configured to generate blueprint data based at least in part on and/or including the spatial data. The service navigation system 140 may be configured to transmit the blueprint data to the service device(s) 170 and/or cause the service device(s) 170 to perform the navigation operation(s) based at least in part on the blueprint data by, for example, displaying a blueprint comprising a graphical depiction of some or all of the premises 50, including some or all of the assets or other objects of the operational system(s) 110 located within and/or associated with the depicted portion of the premises 50.

In various embodiments, the navigation operation(s) caused by the service navigation system 140 and/or performed by any devices associated therewith (e.g., service devices 170, user devices 160) may refer to any operations performed with respect to and/or based on spatial data, blueprint data, and/or renderable blueprints generated by the service navigation system 140, without requiring or being limited to operations specifically performed in a context of performing service on the operational system(s) 110 and/or assets thereof and/or without requiring or being limited to specific instances (or types) of navigation or movement through the premises 50 and/or the operational system(s) 110. For example, in some embodiments, the navigation operation(s) caused and/or performed by the service navigation system 140 and/or the service devices 170 may include simply causing a blueprint and/or blueprint data to be stored (e.g., in the one or more data repositories 150) for later use and/or to be presented or displayed on any user device 160, operated by any type of user and/or in any operational context, without requiring that the spatial data, blueprint data, and/or blueprints be generated specifically in connection with service operations being performed with respect to the operational system(s) 110 and/or assets thereof and/or in connection with particular instances of navigation or movement through the premises 50 and/or operational system(s) 110, and/or without requiring that the spatial data, blueprint data, and/or blueprints be generated based on navigation selection input that is specific to the operational system(s) 110 and/or assets thereof or to any service operations.

While FIG. 1 illustrates certain components as separate, standalone entities communicating over the network 130, various embodiments are not limited to this configuration. In other embodiments, one or more components may be directly connected and/or share hardware or the like.

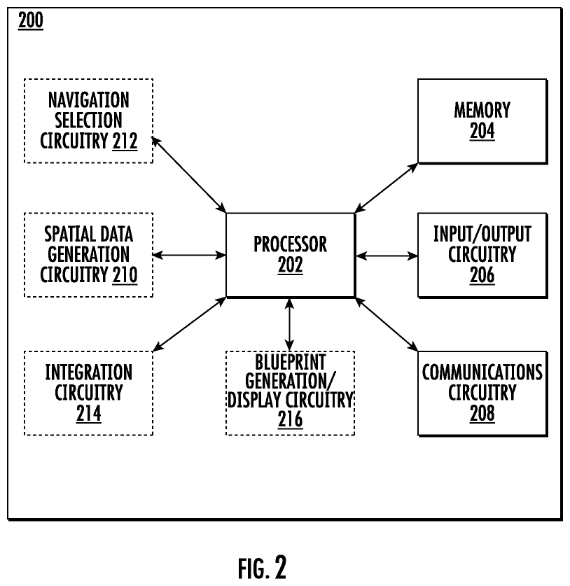

FIG. 2 illustrates an exemplary block diagram of an example apparatus that may be specially configured in accordance with an example embodiment of the present disclosure. Specifically, FIG. 2 depicts an example computing apparatus 200 (“apparatus 200”) specially configured in accordance with at least some example embodiments of the present disclosure. Examples of an apparatus 200 may include, but is not limited to, one or more components of one or more operational systems 110, one or more access control systems 115, a service navigation system 140, one or more data repositories 150, one or more user devices 160, and/or one or more service devices 170. The apparatus 200 includes processor 202, memory 204, input/output circuitry 206, communications circuitry 208, and/or spatial data generation circuitry 210, navigation selection circuitry 212, integration circuitry 214, and/or blueprint generation/display circuitry 216. In some embodiments, the apparatus 200 is configured to execute and perform the operations described herein.

Although components are described with respect to functional limitations, it should be understood that the particular implementations necessarily include the use of particular computing hardware. It should also be understood that in some embodiments certain of the components described herein include similar or common hardware. For example, in some embodiments two sets of circuitry both leverage use of the same processor(s), memory(ies), circuitry(ies), and/or the like to perform their associated functions such that duplicate hardware is not required for each set of circuitry.

In various embodiments, a device, system, or apparatus, such as apparatus 200 of one or more components of one or more operational systems 110, one or more access control systems 115, a service navigation system 140, one or more data repositories 150, one or more user devices 160, and/or one or more service devices 170, may refer to, for example, one or more computers, computing entities, desktop computers, mobile phones, tablets, phablets, notebooks, laptops, distributed systems, servers, or the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein. In one embodiment, these functions, operations, and/or processes can be performed on data, content, information, and/or similar terms used herein. In this regard, the apparatus 200 embodies a particular, specially configured computing entity transformed to enable the specific operations described herein and provide the specific advantages associated therewith, as described herein.

Processor 202 or processor circuitry 202 may be embodied in a number of different ways. In various embodiments, the use of the terms “processor” should be understood to include a single core processor, a multi-core processor, multiple processors internal to the apparatus 200, and/or one or more remote or “cloud” processor(s) external to the apparatus 200. In some example embodiments, processor 202 may include one or more processing devices configured to perform independently. Alternatively, or additionally, processor 202 may include one or more processor(s) configured in tandem via a bus to enable independent execution of operations, instructions, pipelining, and/or multithreading.

In an example embodiment, the processor 202 may be configured to execute instructions stored in the memory 204 or otherwise accessible to the processor. Alternatively, or additionally, the processor 202 may be configured to execute hard-coded functionality. As such, whether configured by hardware or software methods, or by a combination thereof, processor 202 may represent an entity (e.g., physically embodied in circuitry) capable of performing operations according to embodiments of the present disclosure while configured accordingly. Alternatively, or additionally, processor 202 may be embodied as an executor of software instructions, and the instructions may specifically configure the processor 202 to perform the various algorithms embodied in one or more operations described herein when such instructions are executed. In some embodiments, the processor 202 includes hardware, software, firmware, and/or a combination thereof that performs one or more operations described herein.

In some embodiments, the processor 202 (and/or co-processor or any other processing circuitry assisting or otherwise associated with the processor) is/are in communication with the memory 204 via a bus for passing information among components of the apparatus 200.

Memory 204 or memory circuitry embodying the memory 204 may be non-transitory and may include, for example, one or more volatile and/or non-volatile memories. In some embodiments, the memory 204 includes or embodies an electronic storage device (e.g., a computer readable storage medium). In some embodiments, the memory 204 is configured to store information, data, content, applications, instructions, or the like, for enabling an apparatus 200 to carry out various operations and/or functions in accordance with example embodiments of the present disclosure.

Input/output circuitry 206 may be included in the apparatus 200. In some embodiments, input/output circuitry 206 may provide output to the user and/or receive input from a user. The input/output circuitry 206 may be in communication with the processor 202 to provide such functionality. The input/output circuitry 206 may comprise one or more user interface(s). In some embodiments, a user interface may include a display that comprises the interface(s) rendered as a web user interface, an application user interface, a user device, a backend system, or the like. In some embodiments, the input/output circuitry 206 also includes a keyboard, a mouse, a joystick, a touch screen, touch areas, soft keys a microphone, a speaker, or other input/output mechanisms. The processor 202 and/or input/output circuitry 206 comprising the processor may be configured to control one or more operations and/or functions of one or more user interface elements through computer program instructions (e.g., software and/or firmware) stored on a memory accessible to the processor (e.g., memory 204, and/or the like). In some embodiments, the input/output circuitry 206 includes or utilizes a user-facing application to provide input/output functionality to a computing device and/or other display associated with a user.

Communications circuitry 208 may be included in the apparatus 200. The communications circuitry 208 may include any means such as a device or circuitry embodied in either hardware or a combination of hardware and software that is configured to receive and/or transmit data from/to a network and/or any other device, circuitry, or module in communication with the apparatus 200. In some embodiments the communications circuitry 208 includes, for example, a network interface for enabling communications with a wired or wireless communications network. Additionally or alternatively, the communications circuitry 208 may include one or more network interface card(s), antenna(s), bus(es), switch(es), router(s), modem(s), and supporting hardware, firmware, and/or software, or any other device suitable for enabling communications via one or more communications network(s). In some embodiments, the communications circuitry 208 may include circuitry for interacting with an antenna(s) and/or other hardware or software to cause transmission of signals via the antenna(s) and/or to handle receipt of signals received via the antenna(s). In some embodiments, the communications circuitry 208 enables transmission to and/or receipt of data from a user device and/or other external computing device(s) in communication with the apparatus 200.

Navigation selection circuitry 212 may be included in the apparatus 200 (e.g., an apparatus specifically corresponding to the service navigation system 140). The navigation selection circuitry 212 may include hardware, software, firmware, and/or a combination thereof, designed and/or configured to request, receive, process, generate, and transmit data, data structures, control signals, and electronic information for generating the navigation selection interface(s) and/or receiving and/or generating the navigation selection input, including performing any of the operations described herein with respect to the navigation selection interface(s) and/or the navigation selection input.

Spatial data generation circuitry 210 may be included in the apparatus 200 (e.g., an apparatus specifically corresponding to the service navigation system 140). The spatial data generation circuitry 210 may include hardware, software, firmware, and/or a combination thereof, designed and/or configured to request, receive, process, generate, and transmit data, data structures, control signals, and electronic information for generating and/or transmitting spatial data, including performing any of the operations described herein with respect to spatial data. Moreover, in some embodiments, the spatial data generation circuitry 210 may comprise access control circuitry for performing one or more access control operations with respect to spatial data and current users of the service navigation system 140, service devices 170, and/or user devices 160, including generating spatial data based at least in part on asset permissions data and/or access control data (e.g., generating spatial data only for assets, objects, and/or features of the premises 50 that a current user is authorized to access according to the asset permissions data and/or access control data, masking or restricting access to model data and/or spatial data associated with assets, objects, and/or features of the premises 50 that a current user is not authorized to access according to the asset permissions data and/or access control data) and/or including performing any of the operations described herein with respect to access control for the extensible object model(s) and/or any data derived therefrom.

Integration circuitry 214 may be included in the apparatus 200 (e.g., an apparatus specifically corresponding to the service navigation system 140 and/or the access control system(s) 115). The integration circuitry 214 may refer more particularly, in some embodiments, to access control integration circuitry and/or may include hardware, software, firmware, and/or a combination thereof, designed and/or configured to request, receive, process, generate, and transmit data, data structures, control signals, and electronic information for interfacing, communicating, and/or exchanging data with the access control system(s) 115 (e.g., requests for access control data, access requests, commands, instructions), including, in one example, retrieving access control data from the access control system(s) 115 and/or including performing any of the operations described herein with respect to integration with access control system(s) 115.

Blueprint generation/display circuitry 216 may be included in the apparatus 200 (e.g., an apparatus specifically corresponding to the service navigation system 140 and/or service device(s) 170). The blueprint generation/display circuitry 216 may include hardware, software, firmware, and/or a combination thereof, designed and/or configured to request, receive, process, generate, and transmit data, data structures, control signals, and electronic information for generating blueprint data and/or causing rendered blueprints to be displayed by the service device(s) 170, including performing any of the operations described herein with respect to the blueprint data and/or rendered blueprints. Moreover, in some embodiments, the blueprint generation/display circuitry 216 may comprise access control circuitry for performing one or more access control operations with respect to blueprint data and/or rendered blueprints and current users of the service navigation system 140, service devices 170, and/or user devices 160, including generating blueprints based at least in part on asset permissions data and/or access control data (e.g., generating blueprints depicting only assets, objects, and/or features of the premises 50 that a current user is authorized to access according to the asset permissions data and/or access control data, generating blueprints that mask or do not depict any assets, objects, and/or features of the premises 50 that a current user is not authorized to access according to the asset permissions data and/or access control data) and/or including performing any of the operations described herein with respect to access control for the extensible object model(s) and/or any data derived therefrom in the context of rendered blueprints.

In some embodiments, two or more of the sets of circuitries 202-216 are combinable. Alternatively, or additionally, one or more of the sets of circuitry 202-216 perform some or all of the operations and/or functionality described herein as being associated with another circuitry. In some embodiments, two or more of the sets of circuitry 202-216 are combined into a single module embodied in hardware, software, firmware, and/or a combination thereof. For example, in some embodiments, one or more of the sets of circuitry, for example the spatial data generation circuitry 210, may be combined with the processor 202, such that the processor 202 performs one or more of the operations described herein with respect the spatial data generation circuitry 210.

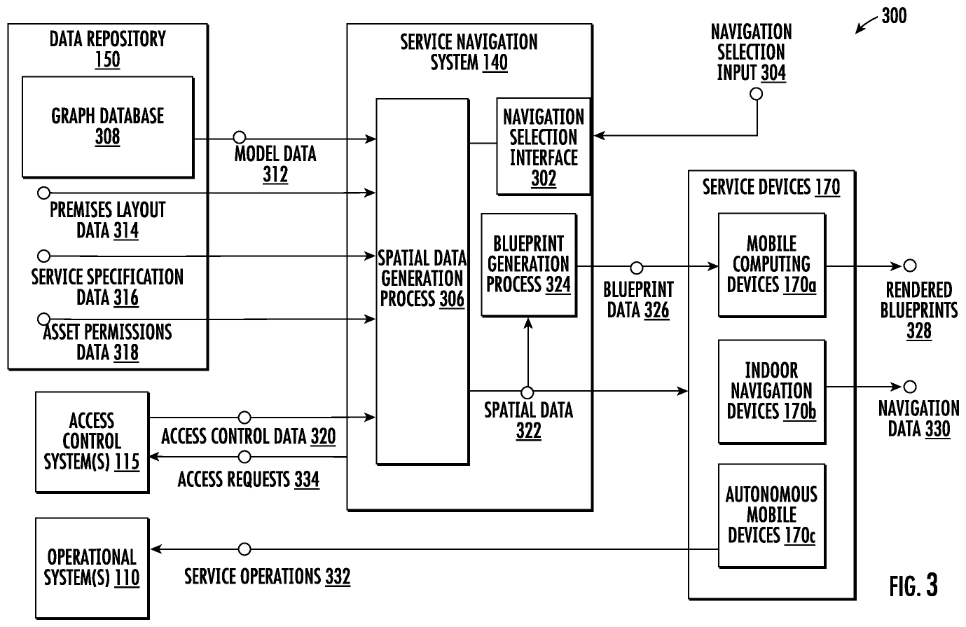

FIG. 3 is an illustration of an example service navigation system 140, in accordance with at least some example embodiments of the present disclosure. Specifically, FIG. 3 includes schematic depictions of the example service navigation system 140, including example internal processes and components of the service navigation system 140, and/or schematic depictions of the one or more data repositories 150, the service device(s) 170, the access control system(s) 115, and the operational system(s) 110 in communication with the service navigation system 140, along with example data objects used by and/or produced by the depicted processes, components, and/or systems. The service navigation system 140 and/or apparatuses 200 associated therewith, for example, may be specially configured via hardware, software, firmware, and/or a combination thereof, to perform the various data processing and interactions described with respect to FIG. 3 to receive navigation selection input, generate spatial data and/or blueprint data using the extensible object model(s), and cause and/or perform navigation operations with respect to the operational system(s) and/or the premises 50.

In the illustrated example, the service navigation system 140 comprises, in some examples, a spatial data generation process 306, a navigation selection interface 302, and a blueprint generation process 324. Additionally, in the illustrated example, the one or more data repositories 150 comprise, in some examples, a graph database 308. Additionally, in the illustrated example, the service devices 170 include mobile computing devices 170a, indoor navigation devices 170b, and autonomous mobile devices 170c.

In various embodiments, the spatial data generation process 306 of the service navigation system 140 may be configured to present the navigation selection interface 302 for receiving navigation selection input 304 (e.g., from user devices 160 based on input detected by the user devices 160) associated with the operational system(s) 110, the premises 50, and/or the extensible object model(s). For example, the spatial data generation process 306 may be configured to present the navigation selection interface 302 within a graphical user interface (GUI) rendered on one or more displays of one or more of the user devices 160, including one or more interactable elements for receiving the navigation selection input 304 (e.g., as user input), for example, as input indicative of selections of selected regions, sites, zones, and/or floors of the premises 50, selected assets of the operational system(s) 110, and/or selected service operations to be performed with respect to the operational system(s) 110 (e.g., represented as objects associated with the operational system(s) 110 by nodes of the extensible object model(s)). In another example, the spatial data generation process 306 may be configured to present the navigation selection interface 302 by exposing an application programming interface (API) configured to receive the navigation selection input 304 (e.g., generated by and transmitted from the user device(s) 160).

In some embodiments, the navigation selection input 304 may comprise data indicating a selected portion of the operational system(s) at the premises 50, a selected portion of the premises 50 (e.g., a selection of one or more features of the premises 50), and/or a selected portion of the extensible object model(s). For example, the navigation selection input 304 may comprise data indicating selected regions, sites, zones, and/or floors of the premises 50, selected assets of the operational system(s) 110, and/or selected service operations to be performed with respect to the operational system(s) 110 (e.g., represented as objects associated with the operational system(s) 110 by nodes of the extensible object model(s)). In one example scenario, in some embodiments, the navigation selection input 304 may comprise data indicating selected features of the premises 50 (e.g., selected regions, sites, zones, and/or floors of the premises 50) without requiring any selections to be included in the navigation selection input 304 that are specific to the operational system(s) 110 and/or assets thereof and/or without requiring any selections specific to service operations to be performed with respect to the operational system(s) 110 and/or assets thereof.

In various embodiments, the spatial data generation process 306 of the service navigation system 140 may be configured to receive, via the navigation selection interface 302, the navigation selection input 304.

The graph database 308 may be a graph database as previously defined and described (e.g., structuring stored data as objects that form nodes and edges, each node representing an object relevant to an operational system and each edge defining a relationship between a pair of nodes). The graph database 308 may be configured to store the extensible object model(s) associated with and/or representing the operational system(s) 110 and/or may be associated with the operational system(s) 110, the service navigation system 140, an enterprise management system for managing the operational system(s) 110. In one example, some or all of the graph database 308 may be embodied in one or more graph database products and/or services (e.g., cloud-based graph database platforms) such as the Neo4j Graph Database product(s) and/or Neo4j AuraDB service(s) produced by Neo4j, Inc.

In some embodiments, the spatial data generation process 306 of the service navigation system 140 may be configured to retrieve model data 312 from the extensible object model(s) stored in the graph database 308, for example, based at least in part on the navigation selection input 304.

For example, the spatial data generation process 306 may be configured to retrieve model data 312 associated with and/or corresponding to selected features of the premises 50 indicated in the navigation selection input 304, including spatial nodes from the extensible object model(s) representing selected regions, sites, zones, and/or floors of the premises 50, any relationships (e.g., spatial relationships) among the spatial nodes, asset nodes from the extensible object model(s) representing assets of the operational system(s) 110 having particular (e.g., predefined) spatial relationships with the spatial nodes (e.g., any assets contained within the selected features of the premise 50), any relationships (e.g., spatial relationships, operational relationships) among the asset nodes and/or between the asset nodes and the spatial nodes, and/or any other object nodes from the extensible object model(s) representing any other objects associated with the operational system(s) 110 having particular spatial, operational, or other relationships with the spatial nodes.

Additionally or alternatively, the spatial data generation process 306 may be configured to retrieve model data 312 associated with and/or corresponding to selected assets of the operational system(s) 110 indicated in the navigation selection input 304, including asset nodes from the extensible object model(s) representing the assets, any relationships (e.g., spatial relationships, operational relationships) among the asset nodes, spatial nodes from the extensible object model(s) representing features of the premises 50 having particular (e.g., predefined) spatial relationships with the asset nodes (e.g., any features of the premises that contain the assets represented by the asset nodes, any features of the premises controlled by the assets represented by the asset nodes), any relationships (e.g., spatial relationships, operational relationships) among the spatial nodes and/or between the spatial nodes and the asset nodes, and/or any other object nodes from the extensible object model(s) representing any other objects associated with the operational system(s) 110 having particular spatial, operational, or other relationships with the asset nodes.

Additionally or alternatively, the spatial data generation process 306 may be configured to retrieve model data 312 associated with and/or corresponding to selected service operations to be performed with respect to the operational system(s) indicated in the navigation selection input 304, including service operation nodes from the extensible object model(s) representing the service operations, any relationships among the service operation nodes, asset nodes and/or spatial nodes from the extensible object model(s) representing, respectively, assets of the operational system(s) and/or features of the premises 50 having particular (e.g., predefined) relationships with the service operation nodes (e.g., any assets of the operational system(s) 110 upon which the service operations represented by the service operation nodes are to be performed, any features of the premises 50 that contain the assets upon which the service operations represented by the service operation nodes are to be performed), any relationships (e.g., spatial relationships, operational relationships) among the asset nodes and/or the spatial nodes and/or between the asset nodes, spatial nodes, and/or service operation nodes, and/or any other object nodes from the extensible object model(s) representing any other objects associated with the operational system(s) 110 having particular spatial, operational, or other relationships with the aforementioned service operation nodes, asset nodes, and/or spatial nodes.

In some embodiments, the spatial data generation process 306 of the service navigation system 140 may be configured to retrieve particular types of data based at least in part on the navigation selection input 304, including, for example, premises layout data 314, service specification data 316, asset permissions data 318, and/or access control data 320. Some or all of the premises layout data 314, service specification data 316, asset permissions data 318, and/or access control data 320 may be part of the model data 312 (e.g., comprising any of the nodes and/or relationships as described above with respect to the model data 312) and/or may be retrieved from sources other than the extensible object model(s) and/or the graph database 308 (e.g., within the one or more data repositories 150 and/or otherwise accessible to the spatial data generation process 306). Any of the premises layout data 314, service specification data 316, asset permissions data 318, and/or access control data 320 not retrieved directly from the extensible object model(s) (and included as part of the retrieved model data 312, for example) may be referenced directly and/or indirectly by the model data 312 and/or may be cross referenced with the model data 312 by the spatial data generation process 306 by any suitable means.

In some embodiments, the premises layout data 314 may comprise data associated with, characterizing, quantifying, and/or representing features of the premises 50, including layout or floorplan images, quantified spatial data (e.g., coordinate data), and/or indications of hazard levels associated with the selections indicated in the navigation selection input 304 (e.g., the selected features of the premises 50), to list a few examples.

In some embodiments, the service specification data 316 may comprise data indicative of characteristics, requirements, and/or procedures associated with various types of maintenance and/or service operations associated with any of the selections indicated in the navigation selection input (e.g., selected assets, selected service operations), including indications of which tools and/or equipment are required for the performance of selected service operations indicated in the navigation selection input 304 and/or for the performance of service operations on the selected assets indicated in the navigation selection input 304 and/or indications of a hazard level associated with the selected service operations and/or the selected assets, to list a few examples.

In some embodiments, the asset permissions data 318 may comprise data indicative of access rights or permissions associated with any of the selections indicated in the navigation selection input (e.g., selected assets and/or types thereof, selected service operations and/or types thereof) with respect to particular users (e.g., of the service navigation system 140, user devices 160, and/or service devices 170) and/or groups of users (e.g., of the service navigation system 140, user devices 160, and/or service devices 170), to list a few examples.

In some embodiments, the access control data 320 may comprise data indicative of access rights or permissions associated with features of the premises 50 (e.g., access points controlled by the access control system(s) 115) based on any of the selections indicated in the navigation selection input 304 (e.g., selected features of the premises 50, features of the premises containing selected assets of the operational system(s) 110, features of the premises 50 containing assets upon which selected service operations are to be performed) with respect to particular users (e.g., of the service navigation system 140, user devices 160, and/or service devices 170) and/or groups of users (e.g., of the service navigation system 140, user devices 160, and/or service devices 170). For example, the access control data 320 may comprise data indicative of which individuals, users, and/or groups of individuals or users are authorized to access which restricted areas and/or to pass through which access points.

The spatial data generation process 306 of the service navigation system 140 may be configured to interface with and/or communicate with the access control system(s) 115 and/or to access the data maintained by the access control system(s) 115 in order to obtain the access control data 320. The spatial data generation process 306 may be configured to retrieve the access control data 320 based at least in part on the navigation selection input 304, including, for example, requesting and/or retrieving particular access control data associated with any of the selections indicated in the navigation selection input 304 (e.g., associated with selected features of the premises 50, associated with features of the premises containing selected assets of the operational system(s) 110, associated with features of the premises 50 containing assets upon which selected service operations are to be performed). In one example, via an integration interface between the access control system(s) 115 and the service navigation system 140 enabling communication and data exchange between the two systems, the spatial data generation process 306 may be configured to generate and transmit a request for the access control data 320 to the access control system(s) 115 and to receive the access control data 320 that is returned by the access control system(s) 115 in response to the request. In another example, the spatial data generation process 306 may be configured to retrieve the access control data 320 from memory (e.g., of the one or more data repositories 150) shared by both the service navigation system 140 and the access control system(s) 115. In some embodiments, the access control data 320 may be included as part of the model data 312 retrieved from the extensible object model(s) stored in the graph database 308.

In some embodiments, the spatial data generation process 306 of the service navigation system 140 may be configured to generate spatial data 322 based at least in part on the model data 312, the premises layout data 314, the service specification data 316, the asset permissions data 318, and/or the access control data 320. The spatial data 322 may comprise some or all of the premises layout data 314 for the premises 50 (or relevant features thereof), location data indicating one or more locations with respect to the premises 50 (or relevant features thereof) of the selected portion of the operational system(s) 110 (as indicated in the navigation selection input 304 and/or represented in the retrieved model data 312 and/or premises layout data 314), position data indicating positions of assets included in the selected portion of the operational system(s) 110 with respect to a layout of the premises 50 and/or other assets, and/or asset data (e.g., included in the retrieved model data 312) identifying and/or characterizing assets included in the selected portion of the operational system(s) 110 and/or any properties of and/or functional relationships between the identified assets.

The spatial data generation process 306 may generate the spatial data 322 by combining and/or cross referencing the retrieved model data 312, premises layout data 314, service specification data 316, asset permissions data 318, and/or access control data 320. The spatial data generation process 306 may be configured to produce the spatial data 322 by further translating the combined and/or cross referenced data into one or more predefined formats specific to and/or associated with one or more service devices 170 and/or one or more navigation operations performed by the service devices 170 such that the translated data may be consumed by the service device(s) 170 and/or cause the service device(s) 170 to perform the navigation operation(s) based at least in part on the spatial data 322.

For example, in some embodiments, the spatial data generation process 306 may be configured to generate the spatial data 322 by combining and/or cross referencing the retrieved model data 312, premises layout data 314, service specification data 316, asset permissions data 318, and/or access control data 320, resulting in the spatial data 322, which may be received by the blueprint generation process 324. The blueprint generation process 324 may be configured to generate blueprint data 326 by further transforming or translating the spatial data 322 to a predefined format specific to and/or associated with a particular navigation operation (namely generating and presenting rendered blueprints 328 via mobile computing devices 170a of the service devices 170) such that the resulting blueprint data 326 may be consumed by the mobile computing devices 170a and/or may cause the mobile computing device 170a to generate and display the rendered blueprints 328.

A rendered blueprint 328 may comprise and/or refer to a graphical depiction of a layout of an area of the premises 50 associated with the selections indicated in the navigation selection input 304 (e.g., corresponding to and/or including the selected features of the premises 50, features of the premises containing selected assets of the operational system(s) 110, features of the premises 50 containing assets upon which selected service operations are to be performed). The rendered blueprint 328 may comprise graphical elements representing features of the premises 50 that represent, are included in, contained within, and/or associated with the depicted area (e.g., areas corresponding to selected features of the premises 50 indicated in the navigation selection input 304). Additionally or alternatively, in some embodiments, the rendered blueprint 328 may comprise graphical elements representing assets (and/or other objects) of the operational system(s) 110 included in, contained within, and/or associated with the depicted area. The graphical elements may be rendered such that they each have particular positions with respect to the depiction of the area of the premises 50, the particular positions corresponding to (e.g., actual, relative) spatial positions of the features of the premises 50 and/or assets or other objects (as defined in the extensible object model(s)).

In some embodiments, the blueprint generation process 324 may be configured to generate the blueprint data 326 to include one or more data objects representing features of the premises 50 and objects associated with the operational system(s) 110, the data object(s) defining for each feature or object how a graphical element representing the feature or object is rendered, including visual characteristic data (e.g., indicating shape, size, color, image, icon type, textual data) and/or position data (e.g., defining absolute and/or relative positions of the graphical element with respect to an extent of the rendered blueprint 328, with respect to a display pane in which the rendered blueprint 328 is displayed, with respect to a map or floorplan image depicting the area in question, and/or with respect to other graphical elements defined by other data objects). The blueprint generation process 324 may be configured to determine the visual characteristic data for each graphical element based at least in part on the type of object or feature represented by the graphical element, including for example different predefined visual characteristic data (or predefined methods for determining the visual characteristic data) associated with and/or assigned to types of features of the premises 50, types of assets of the operational system(s) 110, and/or various types of objects corresponding to items of data in the service specification data 316, asset permissions data 318, and/or access control data 320. The blueprint generation process 324 may be configured to determine the position data for each graphical element based at least in part on spatial relationships indicated for the object (e.g., with respect to other objects) represented by the graphical element, as defined in the spatial data 322 and/or as derived from the model data 312 and premises layout data 314.

For the purposes of illustration, in one example, the blueprint generation process 324 may be configured to generate a first data object for a graphical element representing a first room of the premises 50 and a second data object representing a second room of the premises 50 and may generate the visual characteristic data for both data objects to indicate a predefined shape for the graphical element, the predefined shape being associated with objects of a “room” type (e.g., squares or rectangles of a certain absolute or relative size). The blueprint generation process 324 may further generate the position data for each data object to indicate a relative positions of the graphical elements with respect to each other, the relative positions being determined based on spatial relationships between the nodes representing the two rooms in the model data 312 and/or the premises layout data 314 (e.g., with an “adjacent to” relationship between a node representing the first room and a node representing the second room resulting in position data defining an analogous “adjacent” position for the two graphical elements).

In another example, the blueprint generation process 324 may be configured to generate a first data object for a graphical element representing a room of the premises 50 and a second data object representing an asset of the operational system(s) 110 and may generate the visual characteristic data for the first data object to indicate a predefined shape associated with objects of the “room” type (e.g., squares or rectangles of a certain absolute or relative size), as before, and visual characteristic data for the second data object to indicate a predefined shape associated with objects of the “asset” type (e.g., a circular icon of a certain absolute or relative size). The blueprint generation process 324 may further generate the position data for each data object to indicate relative positions of the graphical elements with respect to each other, the relative positions being determined based on spatial relationships between the nodes representing the room and the asset in the model data 312 and/or the premises layout data 314 (e.g., with a “contains” relationship between a node representing the room and a node representing the asset resulting in position data defining an analogous “contains” position with the graphical element representing the asset overlaid over the graphical element representing the room to indicate that the asset is contained within the room).

Additionally or alternatively, the blueprint generation process 324 may be configured to determine the position data for the graphical elements defined in the blueprint data 326 based at least in part on more precise, quantified (e.g., coordinate) data defined in the premises layout data 314 for the different objects.

Additionally or alternatively, the blueprint generation process 324 may be configured to determine the position data for the graphical elements defined in the blueprint data 326 based at least in part on and/or with respect to one or more images (e.g., from the premises layout data 314) depicting the features of the premises 50 in question, such as a pre-existing floorplan image or map image depicting the area of the premise 50, with the position data defining positions of the graphical elements with respect to the image(s) and the various positions within the image(s) of the depicted features of the premises 50.

In some embodiments, the blueprint generation process 324 may be configured to transmit the blueprint data 326 to one or more mobile computing devices 170a (e.g., operated by one or more service technicians associated with the operational system(s) 110 and/or the premises 50), which may be configured to present (e.g., on a display of the mobile computing devices 170a) the rendered blueprints 328 based at least in part on the blueprint data 326. For example, the mobile computing devices 170a may be configured (e.g., via a service navigation application executing on the mobile computing devices 170a) to generate a graphical element for each of the data objects included in the blueprint data 326 according to the visual characteristic data defined for the data object and to arrange the graphical elements according to the position data defined for the data objects and to display the arrangement of the graphical elements as the rendered blueprint 328. In some embodiments, the blueprint generation process 324 may be configured to perform the operations described above for generating and arranging the graphical elements and to provide the blueprint data 326 to the mobile computing devices 170a in the form of an image, which the mobile computing devices 170a simply display as the rendered blueprints 328.

In various embodiments, the blueprint generation process 324 may generate the blueprint data 326 based at least in part on portions of the spatial data 322 that were derived from the service specification data 316. For example, the blueprint generation process 324 may define graphical elements representing that certain tools and/or equipment are required in connection with a selected service operation and/or in connection with service on a selected asset. These graphical elements may have positions (e.g., defined by the position data) corresponding to the positions of the assets and/or the graphical elements representing the assets. Additionally, these graphical elements may comprise and/or be presented in conjunction with textual data indicating that certain tools and/or equipment are required and/or identifying the required tools and/or equipment. In similar examples, graphical elements of the blueprint data 326 can be generated indicating and/or representing hazard levels associated with assets and/or service operations and/or a need for a backup technician present for service operation.

In various embodiments, the blueprint generation process 324 may generate the blueprint data 326 based at least in part on portions of the spatial data 322 that were derived from the asset permissions data 318. For example, the blueprint generation process 324 may define graphical elements representing only assets and/or other objects that a current user (e.g., of the service devices 170 and/or service navigation system 140) is authorized to access as indicated in the asset permissions data 318 and may exclude from the blueprint data 326 and/or the rendered blueprints 328 any assets and/or other objects that the current user is not authorized to access as indicated in the asset permissions data 318.

In various embodiments, the blueprint generation process 324 may generate the blueprint data 326 based at least in part on portions of the spatial data 322 that were derived from the access control data 320. For example, the blueprint generation process 324 may define graphical elements representing and/or indicating certain features of the premises 50 (e.g., access points) to which a current user (e.g., of the service devices 170 and/or service navigation system 140) is not authorized to access as indicated in the access control data 320 (e.g., cross referenced with the model data 312 and/or premises layout data 314). These graphical elements may have positions (e.g., defined by the position data) corresponding to the positions of the features of the premises 50 and/or the graphical elements representing the features of the premises 50. Additionally, these graphical elements may comprise and/or be presented in conjunction with textual data indicating that the current user does not have access, indicating that the current user needs to request access, and/or providing data concerning how the current user should request access (e.g., providing contact information for entities in charge of granting access). In a similar example, graphical elements can be generated that indicate and/or represent hazard levels associated with assets and/or service operations. In some embodiments, the service navigation system 140 may be configured to automatically generate access requests 334 requesting access for the current user to one or more features of the premises 50 (e.g., through one or more access points) and transmit the access requests 334 to the access control system(s) 115 (e.g., via the integration interface between the service navigation system 140 and the access control system(s) 115).

In various embodiments, the blueprint generation process 324 may generate the blueprint data 326 to include one or more graphical elements representing navigation directions through the premises 50 and/or to assets of the operational system(s) 110 depicted in the blueprint based at least in part on portions of the spatial data 322 that were derived from the model data 312 and/or the premises layout data 314. For example, the blueprint generation process 324 may define graphical elements representing and/or indicating a path through the premises 50 based at least in part on spatial relationships among and/or object types associated with nodes representing various features of the premises 50 and/or assets of the operational system(s) 110. These graphical elements may have positions (e.g., defined by the position data) based on the positions of the features of the premises 50 and/or the graphical elements representing the features of the premises 50 and/or based on types of objects depicted in the blueprint.

In some embodiments, the spatial data generation process 306 may be configured to generate the spatial data 322 by combining and/or cross referencing the retrieved model data 312, premises layout data 314, service specification data 316, asset permissions data 318, and/or access control data 320 and to further transform or translate the combined and/or cross-referenced data to a predefined format specific to and/or associated with a particular navigation operation, namely generating and presenting navigation data 330 via indoor navigation devices 170b (e.g., associated with an indoor navigation system installed at the premises 50) such that the resulting spatial data 322 may be consumed by the indoor navigation devices 170b and/or may cause the indoor navigation devices 170b to generate and display the navigation data 330. For example, the spatial data generation process 306 may be configured to translate absolute and/or relative position data associated with various objects (e.g., as derived from the model data 312 and/or the premises layout data 314) into coordinate data defining the respective locations as coordinates expressed with respect to a coordinate system associated with the indoor navigation system. The spatial data generation process 306 may transmit the spatial data 322 comprising the coordinate data to the indoor navigation devices 170b, which may be configured to present navigation data 330 (e.g., directions through the premises 50 and/or to various assets) as part of an indoor navigation interface of the indoor navigation system.

In some embodiments, the spatial data generation process 306 may be configured to generate the spatial data 322 by combining and/or cross referencing the retrieved model data 312, premises layout data 314, service specification data 316, asset permissions data 318, and/or access control data 320 and to further transform or translate the combined and/or cross-referenced data to a predefined format specific to and/or associated with another particular navigation operation, namely automatic navigation through the premises 50 and/or to assets being serviced, such that the resulting spatial data 322 may be consumed by the autonomous mobile devices 170c and/or may cause the autonomous mobile devices 170c to automatically navigate through the premises 50 and/or to assets being serviced. For example, the spatial data generation process 306 may be configured to translate absolute and/or relative position data associated with various objects (e.g., as derived from the model data 312 and/or the premises layout data 314) into, for example, coordinate data defining the respective locations as coordinates expressed with respect to a coordinate system associated with spatial recognition, machine vision, and/or other relevant systems of the autonomous mobile devices 170c. The spatial data generation process 306 may transmit the spatial data 322 comprising the coordinate data to the autonomous mobile device 170c, which may be configured to automatically move through the premises 50 and/or to the assets indicated in the spatial data 322 based at least in part on the spatial data 322 and to perform one or more service operations 332 with respect to the assets of the operational system(s) 110 indicated in the spatial data 322.

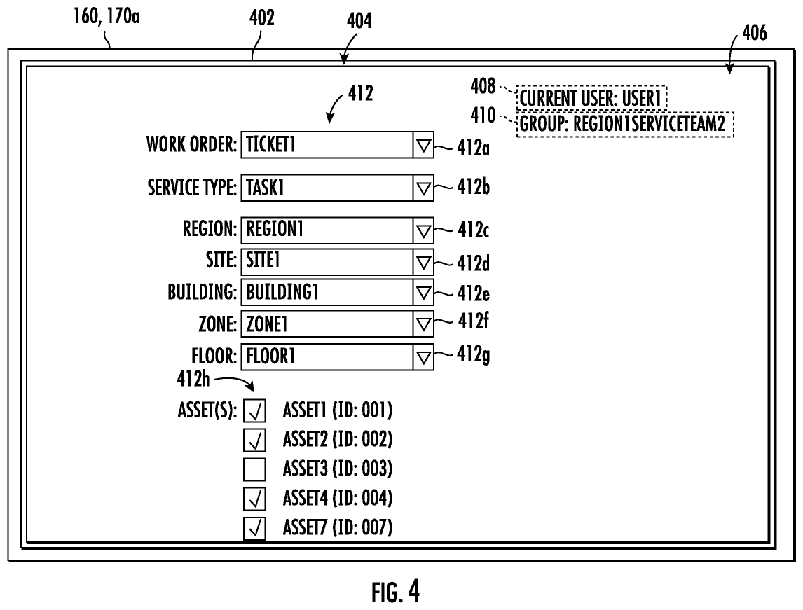

FIG. 4 is an illustration of an exemplary navigation selection screen 406 (e.g., of the navigation selection interface 302). The navigation selection screen 406 may be presented within a GUI 404 rendered on a display 402 of a computing device such as a user device 160 and/or a mobile computing device 170a of the service devices 170. The GUI 404 may be presented as part of a native application user interface or a user interface of a web application (e.g., rendered via a web browser application). The navigation selection screen 406 comprises interactable elements configured to receive (e.g., as user input) the navigation selection input (such as that embodied by the navigation selection input 304 defined and described with respect to FIG. 3).

More particularly, the navigation selection screen 406 comprises a user context indicator 408, a user group context indicator 410, and a series of navigation input selectors 412.

The user context indicator 408 may be a graphical element comprising textual data identifying a user account associated with a current user (e.g., of the service navigation system 140, service devices 170, and/or user devices 160), for example, by indicating a user identifier associated with the user account for the current user. In the illustrated example, the user identifier identifies the current user as “User1.”

Similarly, the user group context indicator 410 may be a graphical element comprising textual data identifying a group (e.g., of user accounts) associated with the user account and/or the current user, for example, by indicating a group identifier associated with the group associated with the current user. In the illustrated example, the group identifier identifies the group associated with the current user as “Region1StrviceTeam2.”

In some embodiments, the user account indicated by the user context indicator 408 and/or the group (e.g., of user accounts) indicated by the group context indicator 410 may correspond to user accounts (or groups thereof) referenced directly or indirectly by any of the extensible object model(s) (including the retrieved model data 312), the asset permissions data 318, and/or the access control data 320.

The service navigation system 140 may be configured to present the navigation selection screen 406 based at least in part on the user account of the current user (e.g., indicated by the user context indicator 408) and/or the group associated with the current user (e.g., indicated by the group context indicator 410). For example, the service navigation system 140 may be configured to present interactable elements 412 enabling selection from one or more sets of objects, with the one or more sets of objects available by selection via the interactable elements 412 being determined based at least in part on the user account of the current user and/or the group associated with the current user (e.g., presenting as selectable options within each set of objects only those objects associated with the current user and/or group).

In particular, the interactable elements 412 include a work order selector 412a, a service type selector 412b, a region selector 412c, a site selector 412d, a building selector 412e, a zone selector 412f, a floor selector 412g, and an asset selector 412h.

In one example, the work order selector 412a may be configured to receive input (e.g., in the form of a selection from a set of work order objects indicated in a drop menu) indicative of a selected work order and/or service ticket (e.g., representing, defining, and/or associated with a selected service operation to be performed with respect to the operational system(s) 110). The work orders and/or service tickets indicated as available for selection via the work order selector 412a may each correspond to a work order object represented by a node of an extensible object model representing an operational system 110. Each of these work order and/or service ticket objects may be associated with one or more users and/or groups of users, and the set of work orders and/or service tickets available for selection via the work order selector 412a may be limited to those with which the current user and/or the current group are associated. For example, the work order and/or service ticket objects available for selection via the work order selector 412a may correspond to particular service operations (e.g., scheduled or generated to be performed with respect to the operational system 110), and the work order and/or service ticket objects available for selection via the work order selector 412a may be limited to those to which the current user has been assigned. In some embodiments, selection of a work order and/or service ticket object via the work order selector 412a may be indicative of a selected service operation, one or more selected assets (e.g., associated with the selected work order), and/or one or more selected features of the premises 50 (e.g., containing or otherwise associated with the assets associated with the selected work order), which may be included in the navigation selection input received via the navigation selection screen 406.

Although the example navigation selection screen 406 depicted in FIG. 4 includes the work order selector 412a for the purposes of illustration, in various embodiments, the work order selector 412a and/or any selections received therefrom may be optional. For example, in some embodiments, a navigation selection screen and/or navigation selection interface may not include the work order selector 412a or any interactable elements analogous thereto. In another example, in some embodiments, a navigation selection screen and/or navigation selection interface may include the work order selector 412a and/or interactable elements analogous thereto but may not require any selection via the work order selector 412a or analogous elements (e.g., any selections concerning work orders and/or service tickets) in order to receive the navigation selection input and/or to generate the spatial data and/or blueprint data.

In another example, the service type selector 412b may be configured to receive input (e.g., in the form of a selection from a set of service type objects indicated in a drop menu) indicative of a selected service type (e.g., associated with a selected service operation to be performed with respect to the operational system(s) 110). The service types indicated as available for selection via the service type selector 412b may each correspond to a service type object represented by a node (or class of nodes) of an extensible object model representing an operational system 110. Each of these service type objects may be associated with one or more users and/or groups of users, and the set of service types available for selection via the service type selector 412b may be limited to those with which the current user and/or the current group are associated. For example, the service type objects available for selection via the service type selector 412b may correspond to particular types of service operations (e.g., to be scheduled or generated to be performed with respect to the operational system 110), and the service type objects available for selection via the service type selector 412b may be limited to those which the current user is authorized to schedule or perform (e.g., according to the extensible object model(s)). In some embodiments, selection of a service type object via the service type selector 412b may be indicative of a selected service operation, which may be included in the navigation selection input received via the navigation selection screen 406.

Although the example navigation selection screen 406 depicted in FIG. 4 includes the service type selector 412b for the purposes of illustration, in various embodiments, the service type selector 412b and/or any selections received therefrom may be optional. For example, in some embodiments, a navigation selection screen and/or navigation selection interface may not include the service type selector 412b or any interactable elements analogous thereto. In another example, in some embodiments, a navigation selection screen and/or navigation selection interface may include the service type selector 412b and/or interactable elements analogous thereto but may not require any selection via the service type selector 412b or analogous elements (e.g., any selections concerning service types) in order to receive the navigation selection input and/or to generate the spatial data and/or blueprint data.

In another example, any or all of the region selector 412c, site selector 412d, building selector 412e, zone selector 412f, and/or floor selector 412g may be configured to receive input (e.g., in the form of a selection from a set of regions, sites, buildings, zones, and/or floors, respectively, indicated in each drop menu) indicative selected features (of various types) of the premises 50. The various features of the premises 50 indicated as available for selection via each of the selectors 412c-412g may each correspond to respective objects represented by nodes of the extensible object model(s). In some embodiments, selection of objects via any of the selectors 412c-412g may be indicative of one or more selected portions of the operational system(s) 110 and/or the extensible object model(s) representing the operational system(s) 110, including selected features of the premises 50 (e.g., represented by the selected objects) and/or selected assets (e.g., contained by or otherwise associated with the selected features of the premises 50), which may be included in the navigation selection input received via the navigation selection screen 406.

Although the example navigation selection screen 406 depicted in FIG. 4 includes the region selector 412c, site selector 412d, building selector 412e, zone selector 412f, and/or floor selector 412g for the purposes of illustration, in various embodiments, some or all of these selectors 412c, 412d, 412e, 412f, 412g and/or any selections received therefrom may be optional. For example, in some embodiments, a navigation selection screen and/or navigation selection interface may not include some or all of these selectors 412c, 412d, 412e, 412f, 412g or any interactable elements analogous thereto. In another example, in some embodiments, a navigation selection screen and/or navigation selection interface may include some or all of the selectors 412c, 412d, 412e, 412f, 412g and/or interactable elements analogous thereto but may not require any selection via the some or all of the selectors 412c, 412d, 412e, 412f, 412g or analogous elements in order to receive the navigation selection input and/or to generate the spatial data and/or blueprint data.

More particularly, in some embodiments, the types of objects referenced and made available for selection via the region selector 412c, site selector 412d, building selector 412e, zone selector 412f, and/or floor selector 412g may be represented in the extensible object model(s) by nodes having one or more hierarchical relationships with the other nodes and/or other types of objects, with some of the objects having a higher order (e.g., parents) within the hierarchy and others having a lower order (e.g., children). For the purposes of illustration, in some embodiments, region objects referenced by and made available for selection via the region selector 412c may have a relatively higher order (e.g., as parents) within the hierarchy than any of the other objects to which the other selectors are associated, with floor objects referenced by and made available for selection via the floor selector 412g having a relatively lower order (e.g., as children) within the hierarchy than any of the other objects to which the other selectors are associated, with similar hierarchical relationships defined with respect to the two previously mentioned object types and the remaining object types (e.g., sites, buildings, zones). In one example, the extensible object model(s) may define a hierarchy in which regions may contain sites, sites contain buildings, buildings contain zones, and zones contain floors. Accordingly, in some embodiments, some or all of the lower order (e.g., child) selectors and/or any selections received therefrom may be optional, with only one or more of the higher order (e.g., parent) selectors and/or selections therefrom being required in order to receive the navigation selection input and/or to generate the spatial data and/or blueprint data. For example, in some embodiments, only a selection of a parent object such as a region (e.g., via the region selector 412c or an analogous element) may be required, with the remaining selectors and/or associated selections being optional.

In another example, the asset selector 412h may be configured to receive input (e.g., in the form of selection/activation of one or more check box selectors corresponding to various asset objects) indicative of one or more selected assets. The assets indicated as available for selection via the asset selector 412h may each correspond to an asset object represented by a node of the extensible object model(s). Each of these asset objects may be associated with one or more users and/or groups of users, and the set of assets available for selection via the asset selector 412h may be limited to those with which the current user and/or the current group are associated. For example, the asset objects available for selection via the asset selector 412h may correspond to particular assets of the operational system(s) 110, and the asset objects available for selection via the asset selector 412h may be limited to those which the current user is authorized to access (e.g., according to the asset permissions data 318). Additionally or alternatively, the asset objects available for selection via the asset selector 412h may be limited to those which are indicated to be associated with an selected object selected via the other selectors 412a-412g. In some embodiments, selection of one or more asset objects via the asset selector 412h may be indicative of a selected portion of the operational system(s) 110 (e.g., the portion corresponding to the selected assets) and/or one or more selected features of the premises 50 (e.g., containing or otherwise associated with the selected assets), which may be included in the navigation selection input received via the navigation selection screen 406.

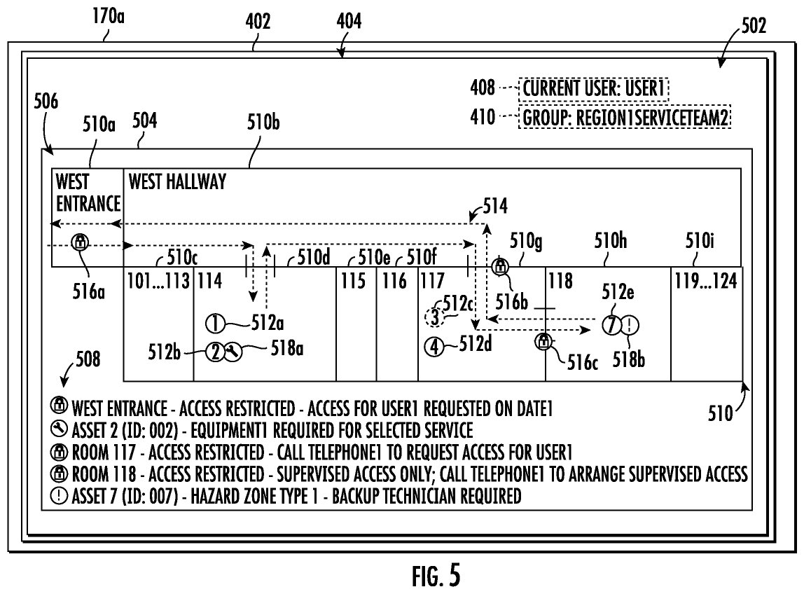

FIG. 5 is an illustration of an exemplary blueprint screen 502. The blueprint screen 502 may be presented within a GUI 404 rendered on a display 402 of a computing device such as a user device 160 and/or a mobile computing device 170a of the service devices 170. The GUI 404 may be presented as part of a native application user interface or a user interface of a web application (e.g., rendered via a web browser application). The blueprint screen 502 presents rendered blueprints (such as those embodied by the rendered blueprints 328 defined and described with respect to FIG. 3).

Similar to the navigation selection screen 406, in the illustrated example, the blueprint screen 502 comprises the user context indicator 408 and the user group context indicator 410. Additionally, in the illustrated example, the blueprint screen 502 comprises a blueprint pane 504, which is configured to display a blueprint 506, which may be an example of and/or comprised by the rendered blueprints 328 defined and described with respect to FIG. 3. The blueprint screen 502 also comprises a details pane 508.

The blueprint 506 displayed in the blueprint pane 504 may comprise a series of graphical elements of various types, including, for example, premises feature graphical elements 510, asset graphical elements 512, navigation indicators 514, access control graphical elements 516, and/or service specification graphical elements 518. In one example, each of these graphical elements may correspond to a data object generated by the spatial data generation process 306 and included in the blueprint data 326. Accordingly, visual characteristics (e.g., shape, size, color, image, icon type, textual data) of each of the graphical elements rendered as part of the blueprint 506 may be defined by and/or determined based at least in part on the visual characteristic data of the data object representing the graphical element in the blueprint data 326. Similarly, positions (e.g., with respect to an extent of the blueprint 506, with respect to the blueprint pane 504, with respect to background image provided as part of the blueprint 506, and/or with respect to other graphical elements) of each of the graphical elements rendered as part of the blueprint 506 may be defined by and/or determined based at least in part on the position data of the data object representing the graphical element in the blueprint data 326.

More particularly, the premises feature graphical elements 510 may each represent a feature of the premises 50 such as an entrance, a hallway, or a room, to list a few examples. In the illustrated example, the blueprint 506 comprises an entrance graphical element 510a, a hallway graphical element 510b, a first room graphical element 510c, a second room graphical element 510d, a third room graphical element 510e, a fourth room graphical element 510f, a fifth room graphical element 510g, a sixth room graphical element 510h, and a seventh room graphical element 510i, which may respectively represent an entrance of the premises 50, a hallway of the premises 50, and a series of rooms of the premises 50.

Each of the premises feature graphical elements 510 may have visual characteristics (e.g., shape, size, text) corresponding to various properties associated with the features of the premises 50 represented by the premises feature graphical elements 510, including names or identifiers associated with the features of the premises 50 (e.g., indicated via textual data contained within or overlaid over the graphical element), types of features of the premises 50 (e.g., different sizes for the graphical elements representing an entrance, room, hallway, door), and/or relationships between the features of the premises 50 and other objects represented by other graphical elements (e.g., different sizes and/or formatting of textual data based on whether a premises feature graphical element 510 contains or is overlaid by graphical elements representing any other objects). In one example, the hallway graphical element 510b may have an elongated shape relative to the other graphical elements 510a, 510-c-i by virtue of representing a “hallway” type feature of the premises 50 and/or by virtue of representing a feature of the premises 50 having certain spatial relationships with various other features of the premises 50 represented by the other graphical elements 510, namely a common edge along its length shared with all of the rooms represented by the room graphical elements 510c-i (e.g., as defined in the spatial data 322 and/or derived from the model data 312 and/or premises layout data 314 via various nodes and relationships between the various nodes in the extensible object model(s)).

Moreover, each of the premises feature graphical elements 510 may be arranged in positions with respect to each other and/or with respect to the blueprint pane 504 (or extent of the blueprint 506) based at least in part on spatial relationships between the various features of the premises 50 as defined in the spatial data 322 generated by the spatial data generation process 306 and as derived from the model data 312 and/or premises layout data 314.

For example, the entrance graphical element 510a representing the entrance to the premises 50 may be positioned at or directly adjacent to an edge of the blueprint pane 504 (or extent of the blueprint 506), while the other graphical elements 510b-i representing interior features of the premises 50 (e.g., hallway, rooms, doors) may be positioned further from the edge of the blueprint pane 504 relative to the entrance graphical element 510b, by virtue of the entrance of the premises 50 and the various internal features of the premises 50 having analogous positions with respect to an exterior of the premises 50 and these positions being reflected in the spatial relationships between the various nodes of the extensible object model(s) representing the entrance and internal features.

In another example, the hallway graphical element 510b may be positioned directly adjacent to an inner edge of the entrance graphical element 510a (directly opposed to the edge of the entrance graphical element 510a that is adjacent to the edge of the blueprint pane 504) by virtue of an analogous spatial relationship between the respective features of the premises 50 being defined in the extensible object model(s) and/or the premises layout data 314.

In yet another example, the hallway graphical element 510b, which has the elongated shape, may be rendered such that it shares a common edge along its length with each of the room graphical elements 510c-510i by virtue of the extensible object model(s) and/or premises layout data 314 defining spatial relationships (e.g., adjacency, connection) between the hallway represented by the hallway graphical element 510b and each of the rooms represented by the room graphical elements 510c-510i with respect to the same wall, edge, or boundary of the hallway (which may be represented in the extensible object model(s) and/or premises layout data 314 by a property of the node representing the hallway, a property of the relationships between the nodes representing the hallway and those representing the rooms, and/or by a node, to list a few examples). Moreover, the room graphical elements 510c-510i are rendered such that they are positioned along the length of the hallway graphical element 510b in a particular order with respect to each other by virtue of the extensible object model(s) and/or premises layout data 314 defining spatial relationships (e.g., adjacency, connection) among the rooms represented by the room graphical elements 510c-510i reflecting the particular order (which may be represented in the extensible object model(s) and/or premises layout data 314 by properties of the relationships between the node representing the hallway and those representing the rooms indicative of the particular order, or properties of the nodes or relationships in question indicating particular edges, walls, or boundaries of each room as a point of connection for a succeeding room, thereby establishing the particular order, among other examples).

The asset graphical elements 512 may each represent an asset of the operational system(s) 110. In the illustrated example, the blueprint 506 comprises a first asset graphical element 512a, a second asset graphical element 512b, a third asset graphical element 512c, a fourth asset graphical element 512d, and a fifth asset graphical element 512e. In one example, each of the asset graphical elements 512 may correspond to one of the selected assets indicated on the navigation selection screen 406 illustrated in FIG. 4. For example, the first asset graphical element 512a may correspond with the asset indicated as “Asset1 (ID: 001),” the second asset graphical element 512b may correspond with the asset indicated as “Asset2 (ID: 002),” the third asset graphical element may correspond with the asset indicated as “Asset3 (ID: 003),” the fourth asset graphical element may correspond with the asset indicated as “Asset4 (ID: 004),” and the fifth asset graphical element may correspond with the asset indicated as “Asset7 (ID: 007).”

Each of the asset graphical elements 512 may have visual characteristics (e.g., shape, text, thickness of perimeter or dotted/dashed quality of perimeter) corresponding to various properties associated with the assets represented by the asset graphical elements 512, including names or identifiers associated with the assets (e.g., indicated via textual data contained within or overlaid over the graphical element) and/or whether the assets were indicated as one of the selected assets in the navigation selection input 304 (e.g., indicated via the perimeter of the graphical element representing the asset being less thick relative to the other graphical elements or being dashed or dotted as opposed to solid). For example, each of the asset graphical elements 512 contains (or is overlaid by) text corresponding to an asset identifier associated with the asset represented by the asset graphical element 512 such as “1” for the first asset graphical element 512a, “2” for the second asset graphical element 512b, and so forth. In another example, the third asset graphical element 512c may have a dashed or dotted perimeter by virtue of the asset represented by the third asset graphical element 512c (“Asset3 (ID: 003)”) being omitted from the selected assets indicated in the navigation selection input 304 as illustrated on the navigation selection screen 406.

Moreover, each of the asset graphical elements 512 may be arranged in positions with respect to the various premises feature graphical elements 510 based at least in part on spatial relationships between the assets represented by the asset graphical elements 512 and the features of the premises 50 represented by the premises feature graphical elements 510 as defined in the spatial data 322 generated by the spatial data generation process 306 and as derived from the model data 312 and/or premises layout data 314. More particularly, each particular asset graphical element 512 may be rendered such that it is contained within (or overlaid over) a particular premises feature graphical element 510 representing a feature of the premises 50 that has a particular spatial relationship (e.g., containing, enclosing) with the asset represented by the particular asset graphical element 512 as indicated in the spatial data 322, model data 312, and/or extensible object model(s).

For instance, in the illustrated example, the first asset graphical element 512a and the second asset graphical element 512b are both rendered such that they are contained within (or overlaid over) the second room graphical element 510d by virtue of the room of the premises 50 represented by the second room graphical element 510d containing the assets represented by the first and second asset graphical elements 512a, 512b and by virtue of this spatial relationship being defined in the extensible object model(s). Similarly, the third asset graphical element 512c and the fourth asset graphical element 512d are both rendered such that they are contained within (or overlaid over) the fifth room graphical element 510g by virtue of the room of the premises 50 represented by the fifth room graphical element 510g containing the assets represented by the third and fourth asset graphical elements 512c. 512d and by virtue of this spatial relationship being defined in the extensible object model(s). In yet another example, the fifth asset graphical element 512e is rendered such that it is contained within (or overlaid over) the sixth room graphical element 510h by virtue of the room of the premises 50 represented by the sixth room graphical element 510h containing the asset represented by the fifth asset graphical element 512e and by virtue of this spatial relationship being defined in the extensible object model(s).

The access control graphical elements 516 may each represent an access point of the premises 50 controlled by the access control system(s) 115. Each of the access points represented by the access control graphical elements 516 may correspond to an access point indicated in the access control data 320, the model data 312, and/or the premises layout data 314. In the illustrated example, the blueprint 506 comprises a first access control graphical element 516a, a second access control graphical element 516b, and a third access control graphical element 516c.

Each of the access control graphical elements 516 may have one or more predefined visual characteristics (e.g., shape, icon symbol) associated with access control graphical elements 516 and/or access points. For example, each of the access control graphical elements 516 may be rendered such that it contains (or is overlaid by) an icon symbol comprising a graphical depiction specific to access control graphical elements 516, such as a graphical depiction of a lock.

The service navigation system 140 may be configured to generate the blueprint data 326 to include data objects defining each of the access control graphical elements 516 based at least in part on the access control data 320. For example, the blueprint generation process 324 may be configured to determine whether any access points controlled by the access control system(s) 115 are contained within and/or associated with any of the features of the premises 50 included in the spatial data 322 and blueprint data 326 and, in response, to determine for each access point controlled by the access control system (s) 115 contained within and/or associated with the features included in the spatial data 322 whether the access control data 320 indicates that the current user is authorized to access or pass through the access point. In response to determining that the current user is not authorized to access an access point, the blueprint generation process 324 may be configured to generate and include in the blueprint data 326 a data object representing an access control graphical element 516 and to include in the generated data object additional data associated with the access point, including a name or identifier associated with the access point, an access control status associated with the access point with respect to the current user, an access request status associated with the access point with respect to the current user, and/or access request instruction data associated with the access point, which data may be displayed as part of the rendered blueprint.

Moreover, each of the access control graphical elements 516 may be arranged at a position with respect to the blueprint 506 and/or the graphical elements thereof (e.g., premises feature graphical elements 510) corresponding to a position of the access point represented by the access control graphical element 516 based at least in part on spatial relationships between the access points represented by the access control graphical elements 516 and other features of the premises 50 represented by other graphical elements (e.g., premises feature graphical elements 510), as defined in the spatial data 322 generated by the spatial data generation process 306 and as derived from the model data 312 and/or premises layout data 314. More particularly, each particular access control graphical element 516 may be rendered such that it is contained within or overlaid over a portion of, or all of, one or more premises feature graphical elements 510 representing one or more features of the premises 50 that have particular spatial and/or operational relationships (e.g., proximity to, controlled or restricted by, connected by) with the particular access control graphical element 516 as indicated in the spatial data 322, model data 312, and/or extensible object model(s).

For instance, in the illustrated example, the first access control graphical element 516a is rendered such that it is contained within (or overlaid over) the entrance graphical element 510a by virtue of the entrance to the premises 50 represented by the entrance graphical element 510a being controlled and/or restricted by the access point represented by the first access control graphical element 516a, by virtue of the access point represented by the first access control graphical element 516a being located at the location of the entrance of the premises 50, and/or by virtue of these operational and/or spatial relationships being defined in the extensible object model(s). In another example, the second access control graphical element 516b is rendered such that it is overlaid over a common edge shared between the hallway graphical element 510b and the fifth room graphical element 510g by virtue of a connection (e.g., door) between the hallway and the room of the premises 50 represented by the hallway graphical element 510b and the fifth room graphical element 510g being controlled and/or restricted by the access point represented by the second access control graphical element 516b, by virtue of the access point represented by the second access control graphical element 516b being located at a location between (e.g., interposed between, connecting) the hallway and the room represented by the fifth room graphical element 510g, and/or by virtue of these operational and/or spatial relationships being defined in the extensible object model(s). In another example, the third access control graphical element 516c is rendered such that it is overlaid over a common edge shared between the fifth room graphical element 510 and the sixth room graphical element 510h by virtue of a connection (e.g., door) between the two rooms of the premises 50 represented by the fifth room graphical element 510g and the sixth room graphical element 510h being controlled and/or restricted by the access point represented by the third access control graphical element 516c, by virtue of the access point represented by the third access control graphical element 516c being located at a location between (e.g., interposed between, connecting) the two rooms, and/or by virtue of these operational and/or spatial relationships being defined in the extensible object model(s).

The service specification graphical elements 518 may each represent items of the service specification data 316 associated with an asset and/or other object of the operational system(s) 110. In the illustrated example, the blueprint 506 comprises a first service specification graphical element 518a and a second service specification graphical element 518b.

Each of the service specification graphical elements 518 may have one or more predefined visual characteristics (e.g., shape, icon symbol) associated with different types of items of service specification data 316. For example, a service specification graphical element 516 associated with an item of the service specification data 316 concerning tools and/or equipment required for service may be rendered such that it contains (or is overlaid by) an icon symbol comprising a graphical depiction specific to required tools and/or equipment, such as a graphical depiction of a tool. In another example, a service specification graphical element 516 associated with an item of the service specification data 316 concerning hazard levels associated with an asset and/or a service operation may be rendered such that it contains (or is overlaid by) an icon symbol comprising a graphical depiction specific to hazard levels, such as a graphical depiction of an exclamation point (“!”).

For instance, in the illustrated example, the first service specification graphical element 518a is rendered such that it contains (or is overlaid by) an icon symbol comprising a graphical depiction of a tool by virtue of the item of service specification data 316 represented by the first service specification graphical element 518a being of a (e.g., predefined) type representing required tools and/or equipment. In a similar example, in the illustrated example, the second service specification graphical element 518b is rendered such that it contains (or is overlaid by) an icon symbol comprising a graphical depiction of an exclamation point (“!”) by virtue of the item of service specification data 316 represented by the second service specification graphical element 518b being of a (e.g., predefined) type representing hazard levels.

The service navigation system 140 may be configured to generate the blueprint data 326 to include data objects defining each of the service specification graphical elements 518 based at least in part on the service specification data 316. For example, the blueprint generation process 324 may be configured to determine whether any items of data contained within the service specification data 316 are associated with assets and/or other objects of the operational system(s) 110 included in the spatial data 322 and blueprint data 326 and, in response, for each such item of the service specification data 316, to generate and include in the blueprint data 326 a data object representing a service specification graphical element 518 and to include in the generated data object additional data associated with the item of service specification data 316, including a type (e.g., required tools/equipment, hazard levels) and/or textual data associated with (e.g., characterizing) the item of service specification data 316 (and/or data defining how such textual data is to be generated), which type and/or textual data may be displayed as part of the rendered blueprint and/or used to determine visual characteristics of the corresponding graphical element.

Moreover, each of the service specification graphical elements 518 may be arranged at a position with respect to the blueprint 506 and/or the graphical elements thereof (e.g., premises feature graphical elements 510, asset graphical elements 512) corresponding to a location associated with the item of data represented by the service specification graphical element 518, such as, for example, a location of an asset of the operational system(s) 110 to which the item of service specification data 316 is associated, based at least in part on the spatial relationships defined in the spatial data 322 generated by the spatial data generation process 306 and as derived from the model data 312 and/or premises layout data 314. More particularly, each particular service specification graphical element 518 may be rendered such that it is proximal to, connected to, partially overlaid over, or partially overlaid by a portion of, or all of, a premises feature graphical element 510 and/or an asset graphical element 512 with which the particular service specification graphical element 518 is associated.

For instance, in the illustrated example, the first service specification graphical element 518a is rendered such that it is proximal to, connected to, and partially overlaid by the second asset graphical element 512b by virtue of the item of service specification data 316 represented by the first service specification graphical element 518a being associated with the asset represented by the second asset graphical element 512b as indicated in the service specification data 316. Similarly, in the illustrated example, the second service specification graphical element 518b is rendered such that it is proximal to, connected to, and partially overlaid by the fifth asset graphical element 512e by virtue of the item of service specification data 316 represented by the second service specification graphical element 518b being associated with the asset represented by the fifth asset graphical element 512e as indicated in the service specification data 316.

The details pane 508 may present one or more items of textual data, each associated with an access control graphical element 516 and/or a service specification graphical element 518. In one example, the textual data indicated in the details pane 508 for each graphical element may derive from data included in the data object of the blueprint data 326 that represents the graphical element.

For instance, in the illustrated example, the details pane 508 presents items of textual data associated with each of the first access control graphical element 516a, the first service specification graphical element 518a, the second access control graphical element 516b, the third access control graphical element 516c, and the second service specification graphical element 518b.

More particularly, in the illustrated example, the textual data presented in the details pane 508 for the first access control graphical element 516a comprises a name or identifier associated with the access point represented by the first access control graphical element 516a (“West Entrance”), an access control status associated with the access point with respect to the current user (“Access Restricted”), and an access request status associated with the access point with respect to the current user (“access for User1 requested on date1”). The textual data presented in the details pane 508 for the first service specification graphical element 518a comprises a name or identifier associated with the asset of the operational system(s) 110 with which the first service specification graphical element 518a is associated (“Asset2 (ID: 002)”) and textual data associated with (e.g., characterizing) the item of service specification data 316 represented by the first service specification graphical element 518a (“Equipment1 required for selected service”). The textual data presented in the details pane 508 for the second access control graphical element 516b comprises a name or identifier associated with the access point represented by the second access control graphical element 516b (“Room 117”), an access control status associated with the access point with respect to the current user (“Access Restricted”), and access request instruction data associated with the access point with respect to the current user (“call telephone1 to request access for User1”). Similarly, the textual data presented in the details pane 508 for the third access control graphical element 516c comprises a name or identifier associated with the access point represented by the third access control graphical element 516c (“Room 118”), an access control status associated with the access point with respect to the current user (“Access Restricted-supervised access only”), and access request instruction data associated with the access point with respect to the current user (“call telephone1 to arrange supervised access”). Finally, the textual data presented in the details pane 508 for the second service specification graphical element 518b comprises a name or identifier associated with the asset of the operational system(s) 110 with which the second service specification graphical element 518b is associated (“Asset7 (ID: 007)”) and textual data associated with (e.g., characterizing) the item of service specification data 316 represented by the second service specification graphical element 518b (“Hazard Zone Type 1—backup technician required”).

The navigation indicators 514 may individually or collectively represent one or more items of navigation data (e.g., generated by the spatial data generation process 306 and included in the spatial data 322) associated with one or more service operations, such as any service operations indicated as selected service operations in the navigation selection input 304 and/or any service operations associated with other selections (e.g., selected assets, selected features of the premises 50) indicated in the navigation selection input 304. The navigation indicators 514 may represent a navigation path or movement path through the premises 50 and/or the operational system(s) 110 to each asset of the operational system(s) 110 associated with the navigation selection input 304.

The navigation indicators 514 may be arranged at positions with respect to the blueprint 506 and/or the graphical elements thereof (e.g., premises feature graphical elements 510) corresponding to the navigation path or movement path represented by the navigation indicators 514. Moreover, the navigation indicators 514 may have visual characteristics (e.g., arrows, directional indicators) based at least in part on and/or indicative of one or more directions of movement at various portions of the navigation path or movement path represented by the navigation indicators 514. In some embodiments, the spatial data generation process 306 may be configured to determine and include in the spatial data 322 a navigation order with respect to features of the premises 50 and/or assets of the operational system(s) 110 indicated in and/or associated with the navigation selection input 304, the model data 312, and/or the premises layout data 314, the navigation order indicating successive points along a recommended movement path, each point corresponding to a feature of the premises 50 and/or an asset of the operational system(s) 110 that will be depicted in the rendered blueprint 328. The blueprint generation process 324 may be configured to generate and include in the blueprint data 326 one or more data objects representing the navigation indicators 514 based at least in part on the determined navigation order, and the mobile computing devices 170a (e.g., in conjunction with the blueprint generation process 324 and/or the service navigation system 140) may be configured to render as part of the rendered blueprints 328 the navigation indicators 514 such that the navigation indicators 514 visually pass through (and/or are overlaid over) the various graphical elements representing the features of the premises 50 and/or assets of the operational system(s) 110 included in the navigation order and in the order indicated in the navigation order. The depicted navigation path represented by the navigation indicators 514 of the blueprint 506 as rendered may correspond to the navigation order determined by the spatial data generation process 306, which may, in turn, be determined based on a determination of relevant assets (e.g., those indicated in or associated with selections indicated in the navigation selection input 304) and spatial relationships defined in the extensible object model(s) in connection with the relevant assets.

For instance, in the illustrated example, the navigation indicators 514 presented as part of the blueprint 506 are rendered as a series of arrows overlaid over and connecting successive premises feature graphical elements 510, from the entrance graphical element 510a, to the hallway graphical element 510b, to the second room graphical element 510d, back to the hallway graphical element 510b, to the fifth room graphical element 510g, to the sixth room graphical element 510h, back to the fifth room graphical element 510g, back to the hallway graphical element 510b, and back to (and out of) the entrance graphical element 510a. This navigation path may be determined by virtue of the relevant assets being contained by particular rooms of interest (those represented by the second room graphical element 510b, fifth room graphical element 510g, and sixth room graphical element 510i), the entrance represented by the entrance graphical element 510a being determined to be an optimal (e.g., closest) entrance (and exit) with respect to the relevant assets and the rooms of interest, and the hallway represented by the hallway graphical element 510b connecting the entrance represented by the entrance graphical element 510a and the rooms of interest.

Additionally or alternatively, the service navigation system 140 may be configured such that the rendered blueprints 328 indicate a navigation or movement path by one or more other means, such as visual prominence of graphical elements representing features of the premises 50 relevant to a service operation (e.g., containing assets associated with the service operation), a display order indicating an order in which various portions of the rendered blueprints 328 are displayed, textual data presented along with the rendered blueprints 328, and/or limiting premises feature graphical elements of the rendered blueprints 328 only to those representing features of the premises 50 containing assets associated with a service operation and/or having spatial relationships connecting the features containing the assets to each other and to a selected or determined entrance of the premises 50, to list a few examples.

The service navigation system 140 may be configured to determine and/or update the display of the rendered blueprints 328 based at least in part on a user account representing a current user (e.g., of the mobile computing device 170a displaying the rendered blueprints 328).

In some embodiments, the service navigation system 140 may be configured to cause display of a rendered blueprint 328 (e.g., via the generated spatial data 322 and/or blueprint data 326) such that the rendered blueprint 328 comprises asset graphical elements representing any assets associated with the current user (e.g., any assets that the current user is authorized to access according to the asset permissions data 318) and/or such that the rendered blueprint 328 excludes and does not depict any assets not associated with the current user (e.g., any assets that the current user is not authorized to access according to the asset permissions data 318).

Additionally or alternatively, the service navigation system 140 may be configured to cause display of a rendered blueprint 328 (e.g., via the generated spatial data 322 and/or blueprint data 326) such that the rendered blueprint 328 comprises access control graphical elements representing any access points specifically relevant to the current user with respect to a service operation (e.g., any access points that the current user is specifically not authorized to access according to the access control data 320 and thus needs to request authorization or otherwise obtain access) and/or such that the rendered blueprint 328 excludes and does not depict any access points not associated with the current user (e.g., any access points that are not restricted or for which the current user is authorized to access according to the access control data 320 and thus requiring no further actions to obtain access).

Additionally or alternatively, the service navigation system 140 may be configured to cause display of a rendered blueprint 328 (e.g., via the generated spatial data 322 and/or blueprint data 326) such that the rendered blueprint 328 comprises service specification graphical elements representing any items of service specification data 316 specifically relevant to the current user with respect to a service operation and/or such that the rendered blueprint 328 excludes and does not depict any items of service specification data 316 not associated with the current user.

For instance, in the example illustrated in FIG. 5, the blueprint 506 comprises the third asset graphical element 512c, which represents an asset that is, for example, omitted from the selected assets indicated in the navigation selection input 304. As previously described, the third asset graphical element 512c has a dashed or dotted perimeter to indicate its omission from the selected assets. However, the third asset graphical element 512c is still included in the display by virtue of the asset represented by the third asset graphical element 512c being associated with the current user (e.g., by virtue of the asset permissions data indicating that the current user is authorized to access or otherwise associated with the asset in question).

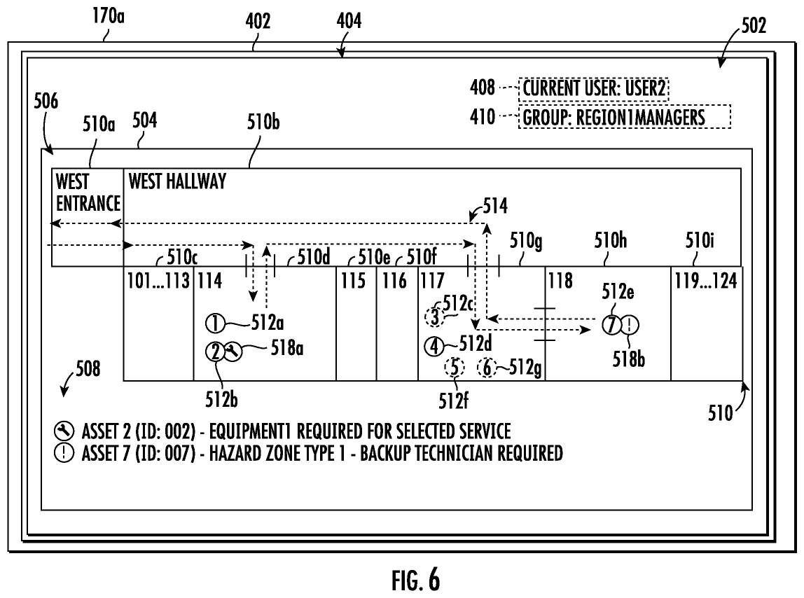

FIG. 6 illustrates the same exemplary blueprint screen 502 as that depicted in FIG. 5, with various aspects of the screen being updated to reflect a different current user as that of FIG. 5. In the illustrated example, the blueprint screen 502 comprises the user context indicator 408, the user group context indicator 410, the blueprint pane 504 (within which the blueprint 506 is displayed along with premises graphical elements 510, asset graphical elements 512, service specification graphical elements 518, and navigation indicators 514), and the details pane 508. The various features included in the illustrated example of FIG. 6 are similar to their analogous counterparts from the illustrated example of FIG. 5.

Now, however, in the illustrated example of FIG. 6, the user context indicator 408 identifies a different user account associated with a different current user, namely “User2.” Similarly, the user group context indicator 410 identifies a different group (e.g., of user accounts) associated with the current user, namely “Region1Managers.”

As previously mentioned, the service navigation system 140 may be configured to present the blueprint screen 502 based at least in part on the user account of the current user (e.g., indicated by the user context indicator 408) and/or the group associated with the current user (e.g., indicated by the group context indicator 410).

For example, the access control indicators 516 included in the blueprint 506 generated and displayed for the user associated with the example of FIG. 5 (“User1”) are not included in the blueprint 506 generated and displayed for the user of the current example of FIG. 6 (“User2”). In this case, the service navigation system 140, upon determining that “User2” is indeed authorized to pass through or access the access points (via individual-level and/or group-level permissions indicated in the access control data 320), may have excluded or omitted from the blueprint 506 any depictions of those access points, which would not require further action by the user “User2” in order to perform the service operation(s) associated with the displayed blueprint 506. Moreover, the details pane 508 is rendered such that it does not include the textual data associated with the various access control indicators 516 that are no longer depicted in the current example of FIG. 6.

Similarly, in the illustrated example of FIG. 6, a sixth asset graphical element 512f and a seventh asset graphical element 512g are included in the blueprint 506 that were not included in the example illustrated in FIG. 5. In this case, the service navigation system 140, upon determining that “User2” is associated with (e.g., authorized to access) the respective assets represented by the sixth asset graphical element 512f and the seventh asset graphical element 512g (via individual-level and/or group-level permissions indicated in the asset permissions data 318), the service navigation system 140 may have included depictions of said assets by virtue of the assets being relevant to the current user (“User2”). Moreover, the example of FIG. 5, considered in comparison to that of FIG. 6, shows how these assets, which are not associated with the current user of that example (“User1”), and which possibly constitute sensitive data that should not be exposed to anyone not authorized to receive such sensitive data, have been masked or omitted from the rendered blueprint 328 that was specifically generated with respect to that current user (“User1”). Similarly, the masked or omitted assets in question are not included as options for selection in the asset selector 412h.

Having described example systems and/or apparatuses of the present disclosure, example flowcharts including various operations performed by the apparatuses and/or systems described herein will now be discussed. It should be appreciated that each of the flowcharts depicts an example computer-implemented process that may be performed by one or more of the apparatuses, systems, and/or devices described herein, for example utilizing one or more of the components thereof. The blocks indicating operations of each process may be arranged in any of a number of ways, as depicted and described herein. In some such embodiments, one or more blocks of any of the processes described herein occur in-between one or more blocks of another process, before one or more blocks of another process, and/or otherwise operates as a sun-process of a second process. Additionally or alternatively, any of the processes may include some or all of the steps described and/or depicted, including one or more optional operational blocks in some embodiments. With respect to the flowcharts discussed below, one or more of the depicted blocks may be optional in some, or all, embodiments of the disclosure. Similarly, it should be appreciated that one or more of the operations of each flowchart may be combinable, replaceable, and/or otherwise altered as described herein.

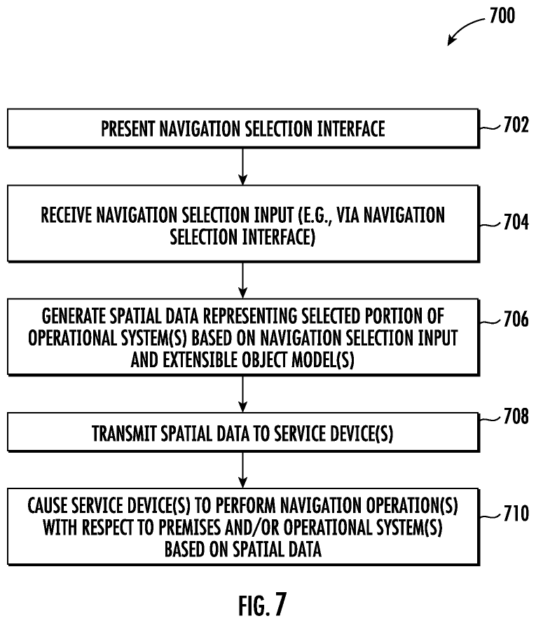

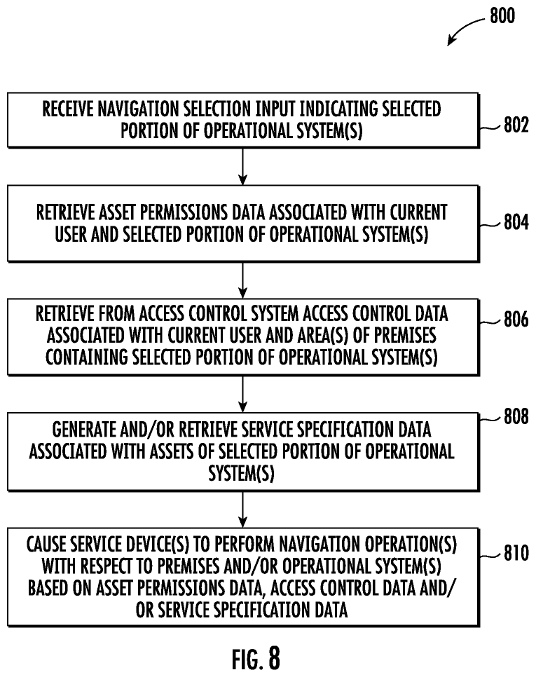

FIGS. 7 and 8 illustrate flowcharts including operational blocks of example processes in accordance with at least some example embodiments of the present disclosure. In some embodiments, the computer-implemented processes of FIGS. 7 and 8 are each embodied by computer program code stored on a non-transitory computer-readable medium of a computer program product configured for execution to perform the computer-implemented method. Alternatively or additionally, in some embodiments, the example processes of FIGS. 7 and 8 are performed by one or more specially configured computing devices, such as the specially configured apparatus 200 (e.g., via navigation selection circuitry 212, spatial data generation circuitry 210, integration circuitry 214, and/or blueprint generation/display circuitry 216). In this regard, in some such embodiments, the apparatus 200 is specially configured by computer program instructions stored thereon, for example in the memory 204 and/or another component depicted and/or described herein, and/or otherwise accessible to the apparatus 200, for performing the operations as depicted and described with respect to the example processes of FIGS. 7 and 8. In some embodiments, the specially configured apparatus 200 includes and/or otherwise is in communication with one or more external apparatuses, systems, devices, and/or the like, to perform one or more of the operations as depicted and described. While the operational blocks of each of the example processes are depicted in each of FIGS. 7 and 8 in a particular order, this should not be understood as requiring that such operations be performed in the particular order shown or in sequential order, or that all illustrated operations be performed.

FIG. 7 illustrates a flowchart including operational blocks of an example process 700 for generating spatial data based on the extensible object model(s), in accordance with at least some example embodiments of the present disclosure.

The process 700 begins at operation 702, at which an apparatus (such as, but not limited to, the apparatus 200 or circuitry thereof as described above in connection with FIG. 2) presents a navigation selection interface configured to receive navigation selection input with respect to one or more operational systems 110 at a premises 50. The navigation selection interface presented at operation 702 may comprise one or more interactable elements configured to receive input indicative of selections of selected regions, sites, zones, and/or floors of the premises 50, selected assets of the operational system(s) 110, and/or selected service operations to be performed with respect to the operational system(s) 110, to list a few examples. In various embodiments, the navigation selection interface presented at operation 702 may correspond to and/or comprise the navigation selection interface 302 as defined and described with respect to FIG. 3, and presenting the navigation selection interface at operation 702 may comprise some or all of the analogous functionality attributed to the spatial data generation process 306 as described with respect to FIG. 3. Moreover, the navigation selection interface presented at operation 702 may correspond to and/or comprise the navigation selection screen 406 as defined and described with respect to FIG. 4.

At operation 704 of the process 700, an apparatus (such as, but not limited to, the apparatus 200 or circuitry thereof described above in connection with FIG. 2) receives navigation selection input (e.g., via the navigation selection interface presented at operation 702). The navigation selection input received at operation 704 may, for example, indicate a selected portion of the operational system(s) 110 at the premises 50 and/or may indicate selections of selected regions, sites, zones, and/or floors of the premises 50, selected assets of the operational system(s) 110, and/or selected service operations to be performed with respect to the operational system(s) 110. In various embodiments, the navigation selection input received at operation 704 may correspond to and/or comprise the navigation selection input 304 as defined and described with respect to FIG. 3, and receiving the navigation selection input at operation 704 may comprise some or all of the analogous functionality attributed to the spatial data generation process 306 and/or navigation selection interface 302 as described with respect to FIG. 3. Moreover, the navigation selection input received at operation 704 may correspond to and/or comprise some or all of the selections depicted in the example illustrated in and described with respect to FIG. 4.

At operation 706 of the process 700, an apparatus (such as, but not limited to, the apparatus 200 or circuitry thereof described above in connection with FIG. 2) generates spatial data representing the selected portion of the operational system(s) 110 (e.g., included in and/or derived from the navigation selection input received at operation 704) based at least in part on the navigation selection input received at operation 704 and on one or more extensible object models representing the operational system(s) 110. In some embodiments, the spatial data generated at operation 706 may comprise premises layout data for the premises 50, location data indicating a location with respect to the premises 50 of the selected portion of the operational system(s) 110, position data indicating positions of assets included in the selected portion of the operational system(s) with respect to a layout of the premises 50 and/or other assets, and/or asset data identifying and/or characterizing assets included in the selected portion of the operational system(s) 110 and/or functional relationships between the identified assets. Moreover, in various embodiments, the extensible object model(s) upon which the spatial data is generated at operation 706 may correspond to and/or comprise the extensible object model(s) as defined and described with respect to FIGS. 1 and 3, such as the extensible object model(s) stored in the graph database 308 as defined and described with respect to FIG. 3. Additionally, the spatial data generated at operation 706 may correspond to and/or comprise the spatial data 322 and/or the blueprint data 326 defined and described with respect to FIG. 3, and generating the spatial data at operation 706 may comprise some or all of the analogous functionality attributed to the spatial data generation process 306 and/or the blueprint generation process 324 as described with respect to FIG. 3.

At operation 708 of the process 700, an apparatus (such as, but not limited to, the apparatus 200 or circuitry thereof described above in connection with FIG. 2) transmits the spatial data generated at operation 706 to one or more service devices associated with the operational system(s). In various embodiments, the service device(s) to which the spatial data is transmitted at operation 708 may correspond to and/or comprise any or all of the service devices 170 as defined and described with respect to FIGS. 1 and 3, including possibly one or more of the user devices 160 defined and described with respect to FIG. 1 and/or one or more of the mobile computing devices 170a, the indoor navigation devices 170b, and/or the autonomous mobile devices 170c as defined and described with respect to FIG. 3. Moreover, transmitting the spatial data to the service device(s) at operation 708 may comprise some or all of the analogous functionality attributed to the spatial data generation process 306 and/or the blueprint generation process 324 as described with respect to FIG. 3.

At operation 710 of the process 700, an apparatus (such as, but not limited to, the apparatus 200 or circuitry thereof described above in connection with FIG. 2) causes the service device(s) to which the spatial data is transmitted at operation 708 to perform one or more navigation operations with respect to the premises 50 and/or the operational system(s) based at least in part on the spatial data (generated at operation 706 and/or transmitted at operation 708).

In some embodiments, the navigation operation(s) caused to be performed at operation 710 may comprise generating and presenting a blueprint based at least in part on the spatial data, the blueprint comprising a graphical depiction of a layout of an area of the premises 50 containing the selected portion of the operational system(s) with graphical elements representing assets of the operational system(s) 110 included in the selected portion of the operational system(s), with positions of the graphical elements with respect to the graphical depiction of the layout of the area of the premises 50 being determined based at least in part on the spatial data. The blueprint may be presented on one or more of the service device(s) 170 and/or user device(s) 160 defined and described with respect to FIGS. 1 and 3, including the mobile computing device(s) 170a defined and described with respect to FIG. 3. A blueprint generated and presented at operation 710 may correspond to, comprise, and/or be comprised by the rendered blueprints 328 as defined and described with respect to FIG. 3, and generating and presenting the blueprint (and/or causing generation and presentation of said blueprint) at operation 170 may comprise some or all of the analogous functionality attributed to the blueprint generation process 324 and/or the mobile computing devices 170a as described with respect to FIG. 3. Moreover, a blueprint generated and presented at operation 710 may comprise and/or correspond to the blueprint 506 as defined and described with respect to FIGS. 5 and 6. More particularly, in one example, the graphical depiction of the layout of the area may correspond to and/or comprise the premises feature graphical elements 510 (and/or an arrangement thereof) as defined and described with respect to FIGS. 5 and 6. In another example, the graphical elements representing the assets of the operational system(s) 110 may correspond to and/or comprise the asset graphical elements 512 as defined and described with respect to FIGS. 5 and 6.

In some embodiments, the navigation operation(s) caused to be performed at operation 710 may comprise an autonomous mobile device (of the service device(s)), which is configured to perform service on assets of the operational system(s) 110, automatically moving through the premises 50 to the assets of the operational system(s) 110 included in the selected portion of the operational system(s) (included in and/or derived from the navigation selection input received at operation 706) based at least in part on the spatial data. In various embodiments, the autonomous mobile devices caused to automatically move through the premises 50 at operation 710 (according to some embodiments) may correspond to, comprise, and/or be comprised by the autonomous mobile devices 170c as defined and described with respect to FIG. 3. Similarly, the service on the assets of the operational system(s) 110 which the autonomous mobile devices are configured to perform may comprise and/or correspond to the service operations 332 as defined and described with respect to FIG. 3.

In some embodiments, the navigation operation(s) caused to be performed at operation 710 may comprise generating and presenting navigation data via an indoor navigation system associated with the premises 50 based at least in part on the spatial data. In various embodiments, the indoor navigation devices caused to generate and present the navigation data at operation 710 (according to some embodiments) may correspond to, comprise, and/or be comprised by the indoor navigation devices 170b as defined and described with respect to FIG. 3, and such navigation data may correspond to and/or comprise the navigation data 330 defined and described with respect to FIG. 3.

In some embodiments, the navigation selection input received at operation 704 may comprise selections of selected regions, zones, sites, and/or buildings of the premises 50 (e.g., without requiring any of said selections to be associated with any service operations to be performed with respect to the operational system(s) 110), and generating the spatial data based on such navigation selection input may comprise generating and/or storing a blueprint for (e.g., depicting) the selected regions, zones, sites, and/or buildings and/or blueprint data defining said blueprint. The service navigation system 140 may be configured to present or display (e.g., via the user devices 160 and/or service devices 170) the generated blueprint (e.g., without requiring the generation and/or presentation of the blueprint to be associated with any service operations to be performed with respect to the operational system(s) 110). Put another way, the process 700 may comprise generating, storing, and/or displaying (e.g., on demand) a blueprint depicting a portion of the operational system(s) 110 and/or features of the premises 50 based on simply a hierarchical selection (e.g., of a selected region, zone, site, and/or building) of one or more features of the premises 50 rather than, for example, any specific assets of the operational system(s) 110 and/or any specific service operations to be performed with respect to the assets of the operational system(s) 110.

FIG. 8 illustrates a flowchart including operational blocks of an example process 800 for causing or initiating navigation operations based on asset permissions data, access control data, and/or service specification data, in accordance with at least some example embodiments of the present disclosure.

The process 800 begins at operation 802, at which an apparatus (such as, but not limited to, the apparatus 200 or circuitry thereof as described above in connection with FIG. 2) receives navigation selection input indicating a selected portion of one or more operational systems 110. In various embodiments, the navigation selection input received at operation 802 may correspond to, comprise, and/or be part of some or all of the navigation selection input received at operation 704 as described with respect to FIG. 7, and receiving the navigation selection input at operation 802 may correspond to, may comprise, and/or may be included in some or all of the analogous functionality described with respect to operation 704.

At operation 804 of the process 800, an apparatus (such as, but not limited to, the apparatus 200 or circuitry thereof described above in connection with FIG. 2) retrieves asset permissions data associated with a current user and the selected portion of the operational system(s) 110 indicated in the navigation selection input received at operation 802. The asset permissions data retrieved at operation 804 may correspond to and/or comprise the asset permissions data 318 defined and described with respect to FIG. 3, and retrieving the asset permissions data at operation 804 may comprise some or all of the analogous functionality attributed to the spatial data generation process 306 as described with respect to FIG. 3.

At operation 806 of the process 800, an apparatus (such as, but not limited to, the apparatus 200 or circuitry thereof described above in connection with FIG. 2) retrieves from an access control system access control data associated with the current user and one or more areas of the premises 50 containing the selected portion of the operational system(s) 110 indicated in the navigation selection input received at operation 802. In various embodiments, the access control system from which the access control data is retrieved at operation 806 may correspond to and/or be comprised by the access control system(s) 115 as defined and described with respect to FIGS. 1 and 3. Moreover, the access control data retrieved at operation 806 may correspond to and/or comprise the access control data 320 defined and described with respect to FIG. 3, and retrieving the access control data at operation 806 may comprise some or all of the analogous functionality attributed to the spatial data generation process 306 as described with respect to FIG. 3.

At operation 808 of the process 800, an apparatus (such as, but not limited to, the apparatus 200 or circuitry thereof described above in connection with FIG. 2) retrieves service specification data associated with assets of the operational system(s) 110 (e.g., selected assets indicated in the navigation selection input, assets associated with selections indicated in the navigation selection input, assets within selected portion of operational system(s) 110). The service specification data retrieved at operation 808 may correspond to and/or comprise the service specification data 316 as defined and described with respect to FIG. 3, and retrieving the service specification data at operation 808 may comprise some or all of the analogous functionality attributed to the spatial data generation process 306 as described with respect to FIG. 3.

At operation 810 of the process 800, an apparatus (such as, but not limited to, the apparatus 200 or circuitry thereof described above in connection with FIG. 2) causes one or more service devices to perform one or more navigation operations with respect to the premises 50 and/or the operational system(s) 110 based at least in part on the asset permissions data retrieved at operation 804, the access control data retrieved at operation 806, and/or the service specification data retrieved at operation 808. The navigation operation(s) caused to be performed at operation 810 may correspond to, comprise, and/or be included as part of some or all of the navigation operation(s) described with respect to operation 710 of the process 700 depicted in FIG. 7, and causing the service device(s) to perform the navigation operation(s) at operation 810 may correspond to, comprise, and/or be included as part of some or all of the analogous functionality described with respect to operation 710.

In various embodiments, the navigation operation(s) caused to be performed at operation 810 may comprise generating and presenting a blueprint, which may comprise and/or correspond to the analogous functionality defined and described with respect to operation 710 of the process 700 illustrated in FIG. 7.

In some embodiments, a blueprint may be generated and presented at operation 810 based at least in part on the asset permissions data retrieved at operation 804, including generating and presenting (and/or causing generation and presentation of) a blueprint such that the blueprint (e.g., once rendered) comprises graphical elements representing assets associated with the current user (e.g., any assets that the current user is authorized to access according to the retrieved asset permissions data) and/or such that the rendered blueprint excludes and/or does not depict any assets not associated with the current user (e.g., any assets that the current user is not authorized to access according to the asset permissions data 318), as described with respect to FIGS. 3-6.

In some embodiments, a blueprint may be generated and presented at operation 810 based at least in part on the access control data retrieved at operation 806, including generating and presenting (and/or causing generation and presentation of) a blueprint such that the blueprint (e.g., once rendered) comprises graphical elements representing any access points that the current user is not authorized to access according to the access control data and/or such that the rendered blueprint excludes and/or does not depict any access points that are not restricted or for which the current user is authorized to access according to the access control data, as described with respect to FIGS. 3-6. More particularly, the graphical elements representing the access points may correspond to and/or comprise the access control graphical elements 516 as defined and described with respect to FIGS. 5 and 6.

In some embodiments, a blueprint may be generated and presented at operation 810 based at least in part on the service specification data retrieved at operation 808, including generating and presenting (and/or causing generation and presentation of) a blueprint such that the blueprint (e.g., once rendered) comprises graphical elements representing items of the service specification data (e.g., associated with assets of the operational system(s) 110), as described with respect to FIGS. 3-6. More particularly, the graphical elements representing the items of the service specification data may correspond to and/or comprise the service specification graphical elements 518 as defined and described with respect to FIGS. 5 and 6.

In some embodiments, one or more of operations 804, 806, and/or 808 may be optional.

Additionally or alternatively, in some embodiments, the navigation selection input received at operation 802 may comprise selections of selected regions, zones, sites, and/or buildings of the premises 50 (e.g., without requiring any of said selections to be associated with any service operations to be performed with respect to the operational system(s) 110), and the process 800 (e.g., as part of operation 810) may comprise generating the spatial data based on such navigation selection input, including generating and/or storing a blueprint for (e.g., depicting) the selected regions, zones, sites, and/or buildings and/or blueprint data defining said blueprint. The service navigation system 140 may be configured to present or display (e.g., via the user devices 160 and/or service devices 170) the generated blueprint (e.g., without requiring the generation and/or presentation of the blueprint to be associated with any service operations to be performed with respect to the operational system(s) 110). Put another way, the process 800 may comprise generating, storing, and/or displaying (e.g., on demand) a blueprint depicting a portion of the operational system(s) 110 and/or features of the premises 50 based on simply a hierarchical selection (e.g., of a selected region, zone, site, and/or building) of one or more features of the premises 50 rather than, for example, any specific assets of the operational system(s) 110 and/or any specific service operations to be performed with respect to the assets of the operational system(s) 110. As mentioned above, one or more of operations 804, 806, and/or 808 may be optional in this context, and, in the example scenario described above, the process 800 may comprise any combination of the various operations 804, 806, 808 as appropriate. For example, in order to generate, store, and/or display a blueprint based on a (e.g., hierarchical) selection of feature(s) of the premises 50, service specification data may not be required, and, accordingly, operation 808 may not be performed. In another example, in order to generate, store, and/or display a blueprint based on a (e.g., hierarchical) selection of feature(s) of the premises 50, access by a current user to the various features of the premises 50 and/or assets contained therein may not be required by virtue of the generation of the blueprint not being connected to specific service operations, and, accordingly, operation 806 may not be performed.

For the purposes of illustration, the spatial data, blueprint data, and/or blueprint generation functionality attributed to the service navigation system 140 and/or described with respect to the processes 700 and 800 has been described, in some instances, with reference to one or more example scenarios involving service operations to be performed with respect to the operational system(s) 110 and/or assets thereof. However, it should be noted that, additionally or alternatively, in some embodiments, the spatial data, blueprint data, and/or blueprint generation functionality attributed to the service navigation system 140 and/or analogous functionality described with respect to the processes 700 and 800 may be performed in other exemplary scenarios that may or may not involve service operations to be performed with respect to the operational system(s) 110 and/or assets thereof. For example, causing service devices to perform navigation operation(s) with respect to the premises and/or operational system(s) 110 at operation 710 of the process 700 and/or at operation 810 of the process 800 may comprise simply causing a blueprint and/or blueprint data (e.g., generated based on a hierarchical selection of feature(s) of the premises 50) to be stored (e.g., in the one or more data repositories 150) for later use and/or to be presented or displayed on any user device 160, operated by any type of user and/or in any operational context, without the spatial data, blueprint data, and/or blueprints being generated specifically in connection with service operations being performed with respect to the operational system(s) 110 and/or assets thereof.

Although example processing systems have been described in the figures herein, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a repository management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communications network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communications network. Examples of communications networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communications network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed is:

1. An apparatus comprising at least one processor and at least one non-transitory memory comprising program code stored thereon, wherein the at least one non-transitory memory and the program code are configured to, with the at least one processor, cause the apparatus to at least:
receive navigation selection input indicating a selected portion of one or more operational systems at a premises;
generate spatial data representing the selected portion of the one or more operational systems based at least in part on the navigation selection input and on one or more extensible object models representing the one or more operational systems;
transmit the spatial data to one or more service devices associated with the one or more operational systems; and
cause the one or more service devices to perform one or more navigation operations with respect to the premises and the one or more operational systems based at least in part on the spatial data.

2. The apparatus of claim 1, wherein the one or more service devices include a mobile computing device operated by a technician associated with the one or more operational systems, and the one or more navigation operations include generating and presenting a blueprint based at least in part on the spatial data, the blueprint comprising a graphical depiction of a layout of an area of the premises containing the selected portion of the one or more operational systems with graphical elements representing assets of the one or more operational systems included in the selected portion of the one or more operational systems, wherein positions of the graphical elements with respect to the graphical depiction of the layout of the area of the premises are based at least in part on the spatial data.

3. The apparatus of claim 2, wherein the at least one non-transitory memory and the program code are configured to, with the at least one processor, further cause the apparatus to at least:
retrieve service specification data associated with the assets; and
present graphical elements representing the service specification data for each of the assets as part of the blueprint.

4. The apparatus of claim 1, wherein the one or more service devices include an autonomous mobile device configured to perform service on assets of the one or more operational systems, and the one or more navigation operations include the autonomous mobile device automatically moving through the premises to assets of the one or more operational systems included in the selected portion of the one or more operational systems based at least in part on the spatial data.

5. The apparatus of claim 1, wherein the one or more navigation operations include generating and presenting navigation data via an indoor navigation system associated with the premises based at least in part on the spatial data.

6. The apparatus of claim 1, wherein the at least one non-transitory memory and the program code are configured to, with the at least one processor, further cause the apparatus to at least:
present a navigation selection interface configured to receive the navigation selection input; and
receive, via the navigation selection interface, the navigation selection input.

7. The apparatus of claim 6, wherein the navigation selection interface comprises one or more interactable elements configured to receive input indicative of selections of selected regions, sites, zones, and/or floors of the premises, selected assets of the one or more operational system, and/or selected service operations to be performed with respect to the one or more operational systems.

8. The apparatus of claim 1, wherein the at least one non-transitory memory and the program code are configured to, with the at least one processor, further cause the apparatus to at least:
retrieve asset permissions data associated with a current user and the selected portion of the one or more operational systems; and
cause the one or more service devices to perform the one or more navigation operations based at least in part on the asset permissions data.

9. The apparatus of claim 1, wherein the at least one non-transitory memory and the program code are configured to, with the at least one processor, further cause the apparatus to at least:
retrieve from an access control system for the premises access control data associated with a current user and one or more areas of the premises containing the selected portion of the one or more operational systems; and
cause the one or more service devices to perform the one or more navigation operations based at least in part on the asset permissions data.

10. The apparatus of claim 1, wherein the spatial data comprises premises layout data for the premises, location data indicating a location with respect to the premises of the selected portion of the one or more operational system, position data indicating positions of assets included in the selected portion of the one or more operational systems with respect to a layout of the premises and/or other assets, and/or asset data identifying and/or characterizing assets included in the selected portion of the one or more operational systems and/or functional relationships between the identified assets.

11. A computer-implemented method comprising:
receiving navigation selection input indicating a selected portion of one or more operational systems at a premises;
generating spatial data representing the selected portion of the one or more operational systems based at least in part on the navigation selection input and on one or more extensible object models representing the one or more operational systems;
transmitting the spatial data to one or more service devices associated with the one or more operational systems; and
causing the one or more service devices to perform one or more navigation operations with respect to the premises and the one or more operational systems based at least in part on the spatial data.

12. The method of claim 11, wherein the one or more service devices include a mobile computing device operated by a technician associated with the one or more operational systems, and the one or more navigation operations include generating and presenting a blueprint based at least in part on the spatial data, the blueprint comprising a graphical depiction of a layout of an area of the premises containing the selected portion of the one or more operational systems with graphical elements representing assets of the one or more operational systems included in the selected portion of the one or more operational systems, wherein positions of the graphical elements with respect to the graphical depiction of the layout of the area of the premises are based at least in part on the spatial data.

13. The method of claim 12, further comprising:
retrieving service specification data associated with the assets; and
presenting the service specification data for each of the assets as part of the blueprint.

14. The method of claim 11, wherein the one or more service devices include an autonomous mobile device configured to perform service on assets of the one or more operational systems, and the one or more navigation operations include the autonomous mobile device automatically moving through the premises to assets of the one or more operational systems included in the selected portion of the one or more operational systems based at least in part on the spatial data.

15. The method of claim 11, wherein the one or more navigation operations include generating and presenting navigation data via an indoor navigation system associated with the premises based at least in part on the spatial data.

16. The method of claim 11, further comprising:
presenting a navigation selection interface configured to receive the navigation selection input; and
receiving, via the navigation selection interface, the navigation selection input.

17. The method of claim 16, wherein the navigation selection interface comprises one or more interactable elements configured to receive input indicative of selections of selected regions, sites, zones, and/or floors of the premises, selected assets of the one or more operational system, and/or selected service operations to be performed with respect to the one or more operational systems.

18. The method of claim 11, further comprising:
retrieving asset permissions data associated with a current user and the selected portion of the one or more operational systems; and
causing the one or more service devices to perform the one or more navigation operations based at least in part on the asset permissions data.

19. The method of claim 11, further comprising:
retrieving from an access control system for the premises access control data associated with a current user and one or more areas of the premises containing the selected portion of the one or more operational systems; and
causing the one or more service devices to perform the one or more navigation operations based at least in part on the asset permissions data.

20. A computer program product comprising at least one non-transitory computer-readable storage medium having computer-readable program code portions stored therein, the computer-readable program code portions comprising an executable portion configured to:
receive navigation selection input indicating a selected portion of one or more operational systems at a premises;
generate spatial data representing the selected portion of the one or more operational systems based at least in part on the navigation selection input and on one or more extensible object models representing the one or more operational systems;
transmit the spatial data to one or more service devices associated with the one or more operational systems; and
cause the one or more service devices to perform one or more navigation operations with respect to the premises and the one or more operational systems based at least in part on the spatial data.
